(19) United States
(12) Patent Application Publication
(10) Pub. No.: US 2026/0173058 A1
(43) Pub. Date: Jun. 18, 2026

(54) THIN RRC FOR 6G MULTI-CARRIER OPERATION

(71) Applicant: QUALCOMM Incorporated, San Diego, CA (US)

(72) Inventors: Kianoush HOSSEINI, San Diego, CA (US); Mostafa KHOSHNEVISAN, San Diego, CA (US); Heechoon LEE, San Diego, CA (US); Changhwan PARK, San Diego, CA (US); Sibasish DAS, San Diego, CA (US); Jing Jiang, San Diego, CA (US); Arunava CHAUDHURI, San Diego, CA (US); Wei MO, San Diego, CA (US)

(21) Appl. No.: 18/983,155

(22) Filed: Dec. 16, 2024

(51) Int. Cl. H04W 72/0457; H04W 72/0453; H04W 72/231

(52) U.S. Cl. CPC H04W 72/0457; H04W 72/0453; H04W 72/231

(57) ABSTRACT

This disclosure provides methods and apparatuses for multi-carrier operation in wireless communication networks. In various examples, a user equipment (UE) obtains a first radio resource control (RRC) configuration associated with a first carrier, the first carrier being associated with a first cell, a first bandwidth part (BWP) configured for the first cell, or at least one RRC profile respectively including a set of RRC parameters. The UE generates, at least in part from the first RRC configuration, a second RRC configuration associated with a second carrier, the second carrier being associated with a second cell, a second BWP configured for the second cell, or the at least one RRC profile. The UE communicates, with a network entity, over the first carrier and the second carrier. The methods and apparatuses provide lower memory requirements, reduced signaling overhead, and reduced secondary cell (SCell) activation time.

### TECHNICAL FIELD

The present disclosure relates to wireless communication, and more particularly, to methods and apparatuses for multi-carrier operation.

### DESCRIPTION OF THE RELATED TECHNOLOGY

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

One innovative aspect of the subject matter described in this disclosure may be implemented in an apparatus for wireless communication, where the apparatus is a user equipment (UE). The apparatus includes one or more memories, and one or more processors each communicatively coupled with at least one of the one or more memories. The one or more processors, individually or in any combination, are operable to cause the apparatus to obtain a first radio resource control (RRC) configuration associated with a first carrier, the first carrier being associated with a first cell, a first bandwidth part (BWP) configured for the first cell, or at least one RRC profile respectively including a set of RRC parameters; generate, at least in part from the first RRC configuration, a second RRC configuration associated with a second carrier, the second carrier being associated with a second cell, a second BWP configured for the second cell, or the at least one RRC profile; and communicate, with a network entity, over the first carrier and the second carrier.

Another innovative aspect of the subject matter described in this disclosure may be implemented in a method of wireless communication performable at a UE. The method includes obtaining a first RRC configuration associated with a first carrier, the first carrier being associated with a first cell, a first BWP configured for the first cell, or at least one RRC profile respectively including a set of RRC parameters; generating, at least in part from the first RRC configuration, a second RRC configuration associated with a second carrier, the second carrier being associated with a second cell, a second BWP configured for the second cell, or the at least one RRC profile; and communicating, with a network entity, over the first carrier and the second carrier.

Another innovative aspect of the subject matter described in this disclosure may be implemented in an apparatus for wireless communication, where the apparatus is a network entity. The apparatus includes one or more memories, and one or more processors each communicatively coupled with at least one of the one or more memories. The one or more processors, individually or in any combination, are operable to cause the apparatus to send a first RRC configuration associated with a first carrier, the first carrier being associated with a first cell, a first BWP configured for the first cell, or at least one RRC profile respectively including a set of RRC parameters; configure a UE to generate, at least in part from the first RRC configuration, a second RRC configuration associated with a second carrier, the second carrier being associated with a second cell, a second BWP configured for the second cell, or the at least one RRC profile; and communicate, with the UE, over the first carrier and the second carrier.

Another innovative aspect of the subject matter described in this disclosure may be implemented in a method of wireless communication performable at a network entity. The method includes sending a first RRC configuration associated with a first carrier, the first carrier being associated with a first cell, a first BWP configured for the first cell, or at least one RRC profile respectively including a set of RRC parameters; configuring a UE to generate, at least in part from the first RRC configuration, a second RRC configuration associated with a second carrier, the second carrier being associated with a second cell, a second BWP configured for the second cell, or the at least one RRC profile; and communicating, with the UE, over the first carrier and the second carrier.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1A is a diagram illustrating an example of a wireless communications system and an access network.

FIG. 1B shows a diagram illustrating an example disaggregated base station architecture.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and a user equipment (UE) in an access network.

FIGS. 4A and 4B are diagrams illustrating examples of intra-band contiguous carrier aggregation (CA) and intra-band noncontiguous CA, respectively.

FIG. 5 is a diagram illustrating an example of an information element including serving cell common parameters.

FIG. 6 is a diagram illustrating an example of information elements respectively including downlink and uplink bandwidth part (BWP)-specific parameters.

FIGS. 7A-7B are diagrams illustrating examples of medium access control (MAC) control elements (MAC-CEs) for secondary cell (SCell) activation and deactivation.

FIG. 8 is a call flow diagram between a UE and a base station.

FIG. 9 is a flowchart of a method of wireless communication performable at a UE.

FIG. 10 is a flowchart of a method of wireless communication performable at a network entity.

FIG. 11 is a diagram illustrating an example of a hardware implementation for an example apparatus.

FIG. 12 is a diagram illustrating another example of a hardware implementation for another example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

Aspects of the present disclosure relate to next generation, multi-carrier operation and the simplification, or “thinning”, of radio resource control (RRC) configurations for user equipment (UEs). For multi-carrier operation, specifically for aggregate or intra-band component carriers (CCs), the network usually configures a same set of parameters indicated as part of an RRC configuration across CCs. For instance, the network may configure same or similar values for respective RRC parameters across CCs. This behavior is generally observed for multiple frequency ranges, such as Frequency Range 1 (FR1) and Frequency Range 2 (FR2), with minimal or no change in the RRC configurations. Additionally, in some frequency ranges such as FR2, even a quasi-colocation (QCL) source may be common across multiple CCs that are taken from a primary cell (PCell). This suggests that channel conditions may likely be the same across CCs, and that there is no reason to select different sets of parameters. Thus, in current deployments that include aggregation of a large number of independent carriers, such as intra-band carrier aggregation in FR2, the network usually configures associated RRC parameters with same or similar values.

It would be helpful then to leverage such common RRC configurations across CCs to improve efficiency for multi-carrier operation. Such approach would potentially result in lower memory requirements, reduced signaling overhead, and reduced secondary cell (SCell) activation time. For example, usually the UE maintains in a memory several copies of a same set of RRC configurations for different CCs, such as ten RRC configurations for ten respective CCs or SCells in FR2, which would increase requirement on memory size. However, if the same or similar configurations across cells were enforced, the UE would be able to store a smaller portion of these configurations in memory, easing memory requirements. As a result, in cases where memory size is a bottleneck for increasing envelope, the reduced memory requirement of this approach may allow the UE to potentially support a larger number of CCs. For example, if the network guarantees that the configurations across CCs are same or similar, the UE may simply store one RRC configuration for ten CCs in FR2, or one RRC configuration for common parameters across the CCs and portions of other configurations for different parameters or the deltas across CCs. This approach may similarly reduce overhead in signaling and SCell activation time, since the network may not need to take time to configure the UE with the same RRC parameters for multiple CCs.

Accordingly, various aspects of the subject matter described in this disclosure relate generally to wireless communication, and more particularly to multi-carrier operation. Some aspects specifically relate to the simplification or thinning of RRC configurations for UEs. In various examples, apparatuses and methods are provided in which a UE obtains a first RRC configuration associated with a first carrier, the first carrier being associated with a first cell, a first BWP configured for the first cell, or at least one RRC profile respectively including a set of RRC parameters; generates, at least in part from the first RRC configuration, a second RRC configuration associated with a second carrier, the second carrier being associated with a second cell, a second BWP configured for the second cell, or the at least one RRC profile; and communicates, with a network entity, over the first carrier and the second carrier. In various examples, apparatuses and methods are similarly provided in which a network entity such as a base station sends a first RRC configuration associated with a first carrier, the first carrier being associated with a first cell, a first BWP configured for the first cell, or at least one RRC profile respectively including a set of RRC parameters; configures a UE to generate, at least in part from the first RRC configuration, a second RRC configuration associated with a second carrier, the second carrier being associated with a second cell, a second BWP configured for the second cell, or the at least one RRC profile; and communicates, with the UE, over the first carrier and the second carrier.

Thus, particular aspects of the subject matter described in this disclosure may be implemented to realize one or more potential advantages. For example, the disclosed methods and apparatuses may allow the UE and network to leverage common RRC configurations across CCs to improve efficiency for multi-carrier operation. This may be achieved after the network entity sends the UE a first RRC configuration associated with a first carrier, where rather than similarly sending the UE a second RRC configuration associated with a second carrier, the network entity instead configures the UE to generate this second RRC configuration based at least in part from the first RRC configuration. Thus, the UE may efficiently communicate with the network entity over the first carrier and the second carrier in carrier aggregation, for example, in a PCell with a received configuration and an activated SCell with a generated configuration. In addition, the disclosed methods and apparatuses may provide for lower memory requirements, reduced signaling overhead, and reduced secondary cell (SCell) activation time.

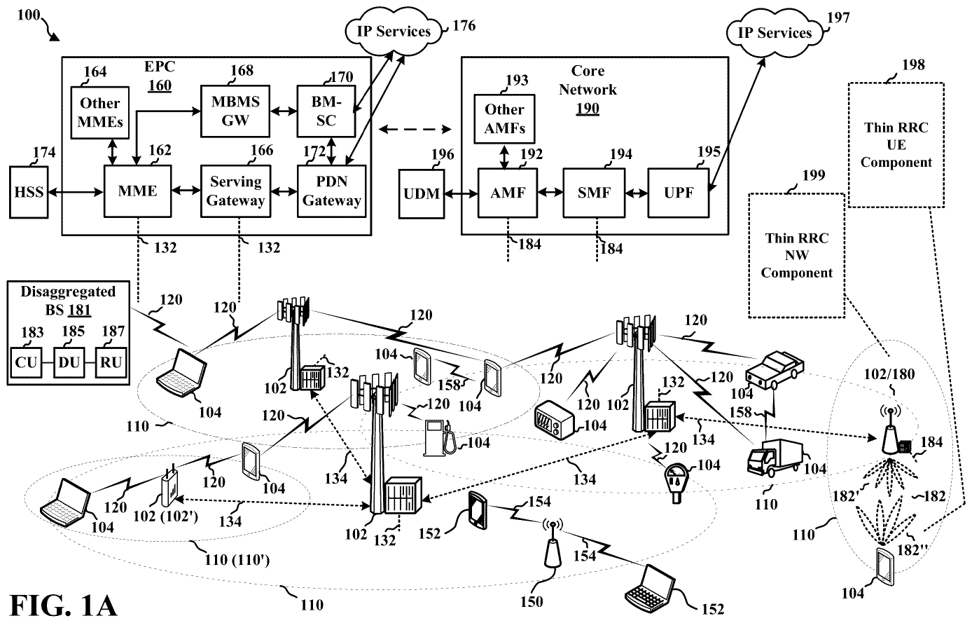

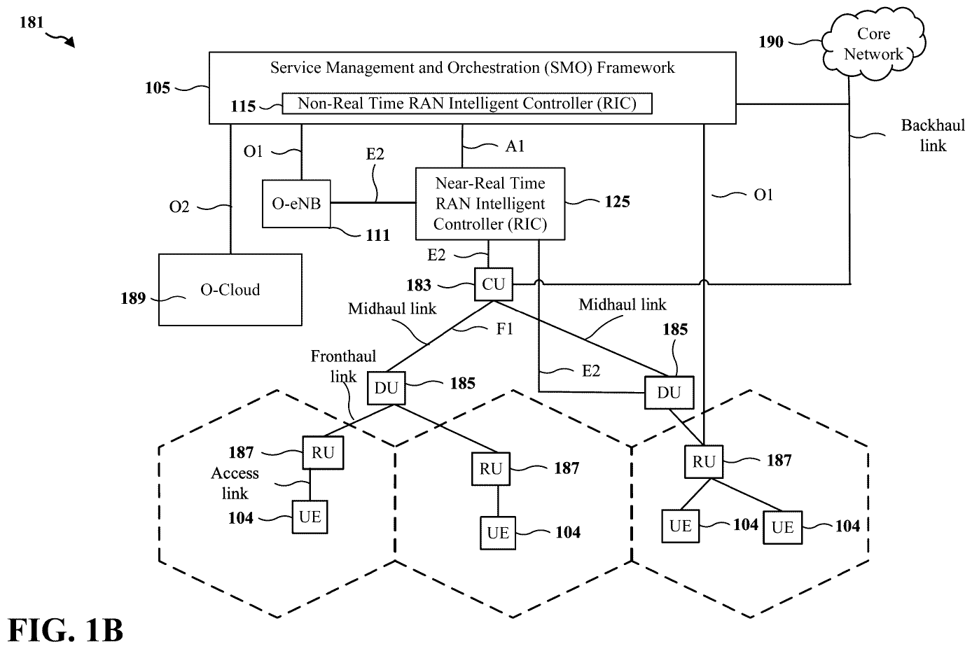

FIG. 1A is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a communications device, a wireless communications device, a remote device, a mobile subscriber station, an access terminal, a mobile terminal, a wireless terminal, a remote terminal, a handset, a user agent, a mobile client, a client, or some other suitable terminology.

Deployment of communication systems, such as 5G NR systems, may be arranged in multiple manners with various components or constituent parts. In a 5G NR system, or network, a network node, a network entity, a network device, a mobility element of a network, a RAN node, a core network node, a network element, or a network equipment, such as a BS, or one or more units (or one or more components) performing base station functionality, may be implemented in an aggregated or disaggregated architecture. For example, a BS (such as a Node B (NB), eNB, NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station 181 may be configured to utilize a protocol stack that is physically or logically distributed among two or more units (such as one or more central units (CU), one or more distributed units (DUs), or one or more radio units (RUs)). In some aspects, a CU 183 may be implemented within a RAN node, and one or more DUs 185 may be co-located with the CU, or alternatively, may be geographically or virtually distributed throughout one or multiple other RAN nodes. The DUs may be implemented to communicate with one or more RUs 187. Each of the CU, DU and RU also may be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which may enable flexibility in network design. The various units of the disaggregated base station, or disaggregated RAN architecture, may be configured for wired or wireless communication with at least one other unit.

FIG. 1B shows a diagram illustrating an example disaggregated base station 181 architecture. The disaggregated base station 181 architecture may include one or more CUs 183 that may communicate directly with core network 190 via a backhaul link, or indirectly with the core network 190 through one or more disaggregated base station units (such as a Near-Real Time RIC 125 via an E2 link, or a Non-Real Time RIC 115 associated with a Service Management and Orchestration (SMO) Framework 105, or both). A CU 183 may communicate with one or more DUs 185 via respective midhaul links, such as an F1 interface. The DUs 185 may communicate with one or more RUs 187 via respective fronthaul links. The RUs 187 may communicate respectively with UEs 104 via one or more radio frequency (RF) access links. In some implementations, the UE 104 may be simultaneously served by multiple RUs 187.

Each of the units, i.e., the CUs 183, the DUs 185, the RUs 187, as well as the Near-RT RICs 125, the Non-RT RICs 115 and the SMO Framework 105, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, may be configured to communicate with one or more of the other units via the transmission medium. For example, the units may include a wired interface configured to receive or transmit signals over a wired transmission medium to one or more of the other units. Additionally, the units may include a wireless interface, which may include a receiver, a transmitter or transceiver (such as a radio frequency (RF) transceiver), configured to receive or transmit signals, or both, over a wireless transmission medium to one or more of the other units.

In some aspects, the CU 183 may host higher layer control functions. Such control functions may include radio resource control (RRC), packet data convergence protocol (PDCP), service data adaptation protocol (SDAP), or the like. Each control function may be implemented with an interface configured to communicate signals with other control functions hosted by the CU 183. The CU 183 may be configured to handle user plane functionality (i.e., Central Unit-User Plane (CU-UP)), control plane functionality (i.e., Central Unit-Control Plane (CU-CP)), or a combination thereof. In some implementations, the CU 183 may be logically split into one or more CU-UP units and one or more CU-CP units. The CU-UP unit may communicate bidirectionally with the CU-CP unit via an interface, such as the E1 interface when implemented in an O-RAN configuration. The CU 183 may be implemented to communicate with the DU 185, as necessary, for network control and signaling.

The DU 185 may correspond to a logical unit that includes one or more base station functions to control the operation of one or more RUs 187. In some aspects, the DU 185 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 185 may further host one or more low PHY layers. Each layer (or module) may be implemented with an interface configured to communicate signals with other layers (and modules) hosted by the DU 185, or with the control functions hosted by the CU 183.

Lower-layer functionality may be implemented by one or more RUs 187. In some deployments, an RU 187, controlled by a DU 185, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 187 may be implemented to handle over the air (OTA) communication with one or more UEs 104. In some implementations, real-time and non-real-time aspects of control and user plane communication with the RU(s) 187 may be controlled by the corresponding DU 185. In some scenarios, this configuration may enable the DU(s) 185 and the CU 183 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements, which may be managed via an operations and maintenance interface (such as an O1 interface). For virtualized network elements, the SMO Framework 105 may be configured to interact with a cloud computing platform (such as an open cloud (O-Cloud) 189) to perform network element life cycle management (such as to instantiate virtualized network elements) via a cloud computing platform interface (such as an O2 interface). Such virtualized network elements may include, but are not limited to, CUs 183, DUs 185, RUs 187 and Near-RT RICs 125. In some implementations, the SMO Framework 105 may communicate with a hardware aspect of a 4G RAN, such as an open eNB (O-eNB) 111, via an O1 interface. Additionally, in some implementations, the SMO Framework 105 may communicate directly with one or more RUs 187 via an O1 interface. The SMO Framework 105 also may include the Non-RT RIC 115 configured to support functionality of the SMO Framework 105.

The Non-RT RIC 115 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 183, one or more DUs 185, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

Referring to FIGS. 1A and 1B, in certain aspects, the UE 104 may include a thin RRC UE component 198 that is configured to obtain a first radio resource control (RRC) configuration associated with a first carrier, the first carrier being associated with a first cell, a first bandwidth part (BWP) configured for the first cell, or at least one RRC profile respectively including a set of RRC parameters; generate, at least in part from the first RRC configuration, a second RRC configuration associated with a second carrier, the second carrier being associated with a second cell, a second BWP configured for the second cell, or the at least one RRC profile; and communicate, with a network entity, over the first carrier and the second carrier. The network entity may be, for example, base station 102/180, disaggregated base station 181, a component of disaggregated base station 181 such as CU 183, DU 185, or RU 187, or some other network node.

Furthermore, in certain aspects, a network entity such as base station 102/180, disaggregated base station 181, or a component of disaggregated base station 181 such as CU 183, DU 185, or RU 187, may include a thin RRC network (NW) component 199 that is configured to send a first RRC configuration associated with a first carrier, the first carrier being associated with a first cell, a first BWP configured for the first cell, or at least one RRC profile respectively including a set of RRC parameters; configure a UE to generate, at least in part from the first RRC configuration, a second RRC configuration associated with a second carrier, the second carrier being associated with a second cell, a second BWP configured for the second cell, or the at least one RRC profile; and communicate, with the UE, over the first carrier and the second carrier.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

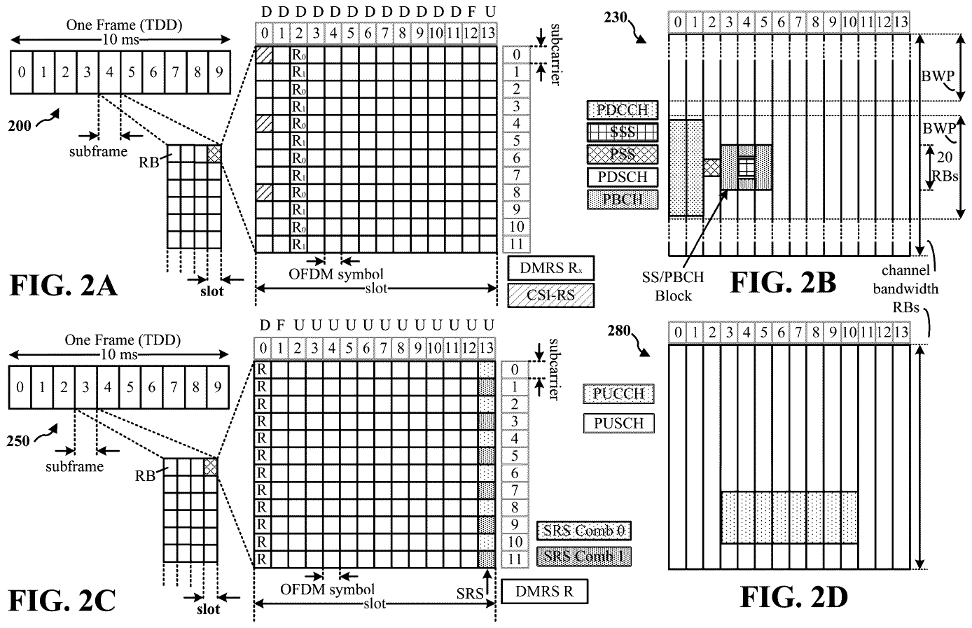

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data and may additionally be used to carry a buffer status report (BSR), a power headroom report (PHR), and/or UCI.

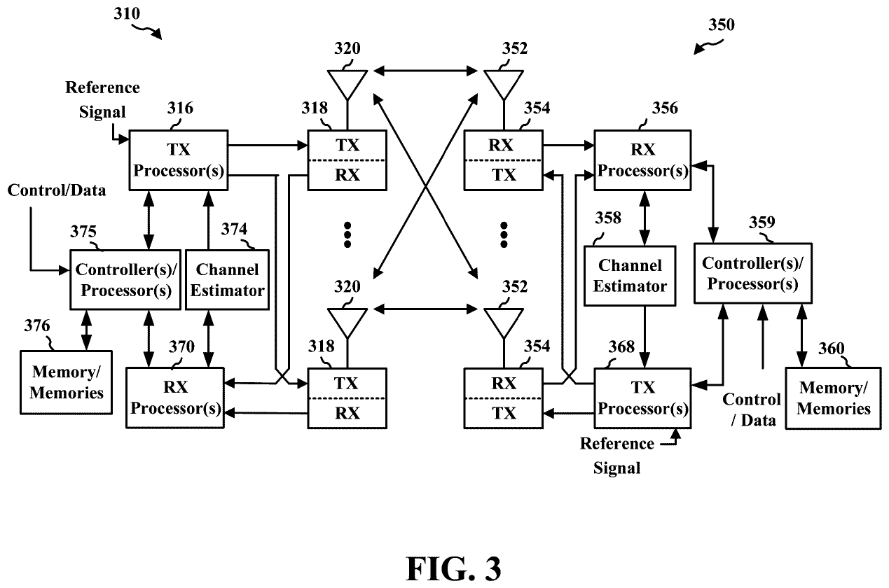

FIG. 3 is a block diagram of a base station 310 in communication with a UE 350 in an access network. In the DL, IP packets from the EPC 160 may be provided to one or more controllers/processors 375. The one or more controllers/processors 375 implement layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The one or more controllers/processors 375 provide RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The one or more transmit (TX) processors 316 and the one or more receive (RX) processors 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The one or more TX processors 316 handle mapping to signal constellations based on various modulation and coding schemes (MCS) (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the one or more receive (RX) processors 356. The one or more TX processors 368 and the one or more RX processors 356 implement layer 1 functionality associated with various signal processing functions. The one or more RX processors 356 may perform spatial processing on the information to recover any spatial streams destined for the UE 350. If multiple spatial streams are destined for the UE 350, they may be combined by the one or more RX processors 356 into a single OFDM symbol stream. The one or more RX processors 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the one or more controllers/processors 359, which implement layer 3 and layer 2 functionality.

The one or more controllers/processors 359 may each be associated with one or more memories 360 that store program codes and data. The one or more memories 360, individually or in any combination, may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). In the UL, the one or more controllers/processors 359 provide demultiplexing between transport and logical channels, packet reassembly, deciphering, header decompression, and control signal processing to recover IP packets from the EPC 160. The one or more controllers/processors 359 are also responsible for error detection using an ACK and/or NACK protocol to support HARQ operations.

Similar to the functionality described in connection with the DL transmission by the base station 310, the one or more controllers/processors 359 provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the one or more TX processors 368 to select the appropriate coding and modulation schemes, and to facilitate spatial processing. The spatial streams generated by the one or more TX processors 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to one or more RX processors 370.

The one or more controllers/processors 375 may each be associated with one or more memories 376 that store program codes and data. The one or more memories 376, individually or in any combination, may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). In the UL, the one or more controllers/processors 375 provide demultiplexing between transport and logical channels, packet reassembly, deciphering, header decompression, control signal processing to recover IP packets from the UE 350. IP packets from the one or more controllers/processors 375 may be provided to the EPC 160. The one or more controllers/processors 375 are also responsible for error detection using an ACK and/or NACK protocol to support HARQ operations.

At least one of the one or more TX processors 368, the one or more RX processors 356, and the one or more controllers/processors 359 may be configured to perform aspects in connection with thin RRC UE component 198 of FIG. 1A.

At least one of the one or more TX processors 316, the one or more RX processors 370, and the one or more controller/processors 375 may be configured to perform aspects in connection with thin RRC NW component 199 of FIG. 1A.

A carrier in wireless communications refers to a modulated waveform conveying a physical channel. For instance, a carrier may refer to a modulated waveform conveying an E-UTRA, UTRA, or GSM physical channel defined by a code, frequency, and in some cases, a time-slot. Each carrier is supported by a channel bandwidth. For instance, a channel bandwidth may refer to a radio frequency (RF) bandwidth supporting a single RF carrier with a transmission bandwidth configured in the uplink or downlink of a cell. A cell refers to a radio network object that may be uniquely identified by a UE from a broadcast identification over a geographical area from an access point, such as by UE 104 within coverage area 110 of FIG. 1A. Examples of cells include primary cells (PCells), secondary cells (SCells), primary secondary cells (PSCell), special cells (SpCell), or other serving cells configured for a UE upon entry in an RRC connected mode. A bandwidth part refers to a subset of contiguous common resource blocks for a given numerology on a given carrier. For instance, a bandwidth part may refer to a subset of contiguous RBs within a channel bandwidth. A serving cell may be configured with one or multiple downlink and uplink BWPs. For example, a UE may be configured with multiple bandwidth parts in the downlink, with a single downlink bandwidth part being active at a given time. If configured for an SCell, the first DL BWP on the carrier to be activated or used upon activation of the SCell is referred to as the first active downlink BWP identifier (ID) given by firstActiveDownlinkBWP-Id. Similarly, UE may be configured with multiple bandwidth parts in the uplink, with a single uplink bandwidth part being active at a given time. If configured for an SCell, the first UL BWP on the carrier to be activated or used upon activation of the SCell is referred to as the first active uplink BWP identifier (ID) given by firstActiveUplinkBWP-Id. Thus, a carrier may be associated with a cell, a bandwidth in a cell, and multiple bandwidth parts in a cell.

Carrier aggregation (CA) refers to an aggregation of two or more carriers, also referred to as component carriers (CCs), in order to support wider transmission bandwidths. Carrier aggregation may be intra-band contiguous, intra-band non-contiguous, or inter-band. Intra-band contiguous CA refers to aggregation of contiguous CCs in a same operating band. Intra-band non-contiguous CA refers to aggregation of non-contiguous CCs in a same operating band. Inter-band CA refers to aggregation of CCs in different operating bands. In some cases, an RF bandwidth may include multiple sub-blocks, which respectively refer to contiguous allocated blocks of spectrum for transmission and reception by a same UE.

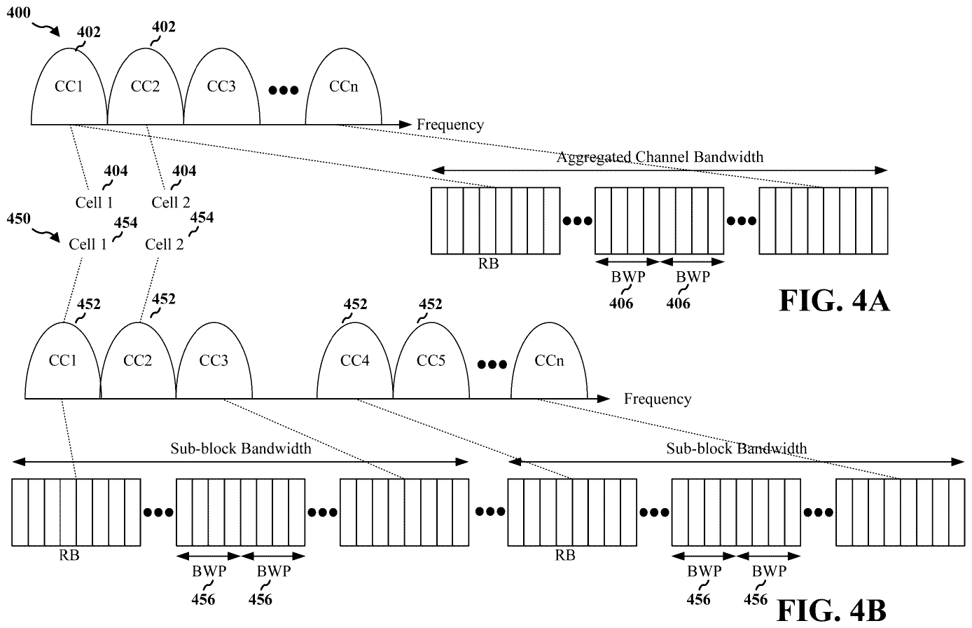

FIGS. 4A and 4B illustrate examples 400, 450 of intra-band contiguous CA and intra-band noncontiguous CA, respectively. In the intra-band contiguous CA example of FIG. 4A, multiple contiguous CCs 402 respectively associated with different cells 404 and BWPs 406 in a same operating band may be aggregated together to span an aggregated channel bandwidth. For example, CC1 may be associated with a first cell such as a PCell including multiple BWPs, CC2 may be associated with a second cell such as an SCell including multiple BWPs, and so forth within the aggregated channel bandwidth. Similarly, in the intra-band non-contiguous CA example of FIG. 4B, multiple CCs 452 respectively associated with different cells 454 and BWPs 456 in sub-blocks of a same operating band may be aggregated together to span an aggregated channel bandwidth. For example, CC1 may be associated with a first cell such as a PCell including multiple BWPs, CC2 may be associated with a second cell such as an SCell including multiple BWPs, and so forth within the aggregated channel bandwidth.

For support of CA, the UE may report supported band combinations and bandwidth classes, as well as associated bandwidth combination sets. For instance, the UE may report a UE capability information element BandCombinationList, which IE contains a list of carrier aggregation band combinations. This IE may also include downlink only or uplink only bands. A given band combination in this list, which may be reported in the IE BandCombination, may indicate various parameters including, for example, band parameters, a feature set combination, and a supported bandwidth combination set. The band parameters for a given band combination, which may be reported in the IE BandParameters, may in turn indicate one or more bands, and bandwidth classes for downlink and uplink. Examples of bandwidth classes are shown below in Table 1.

TABLE 1
Example of NR CA Bandwidth Classes

| NR CA | | Number of | |
|---|---|---|---|
| bandwidth | | contiguous | Fallback |
| class | Aggregated channel bandwidth | CC | group |
| A | BW_{Channel} ≤ BW_{Channel, max} | 1 | 1, 2, 3 |
| B | 20 MHz ≤ BW_{Channel}_{_{—}}_{CA} ≤ 100 | 2 | 2, 3 |
| | MHz | | |
| C | 100 MHz < BW_{Channel}_{_{—}}_{CA} ≤ 2 × | 2 | 1, 3 |
| | BW_{Channel, max} | | |
| D | 200 MHz < BW_{Channel}_{_{—}}_{CA} ≤ 3 × | 3 | |
| | BW_{Channel, max} | | |
| E | 300 MHz < BW_{Channel}_{_{—}}_{CA} ≤ 4 × | 4 | |
| | BW_{Channel, max} | | |
| G | 100 MHz < BW_{Channel}_{_{—}}_{CA} ≤ 150 | 3 | 2 |
| | MHz | | |
| H | 150 MHz < BW_{Channel}_{_{—}}_{CA} ≤ 200 | 4 | |
| | MHz | | |
| I | 200 MHz < BW_{Channel}_{_{—}}_{CA} ≤ 250 | 5 | |
| | MHz | | |
| J | 250 MHz < BW_{Channel}_{_{—}}_{CA} ≤ 300 | 6 | |
| | MHz | | |
| K | 300 MHz < BW_{Channel}_{_{—}}_{CA} ≤ 350 | 7 | |
| | MHz | | |
| L | 350 MHz < BW_{Channel}_{_{—}}_{CA} ≤ 400 | 8 | |
| | MHz | | |
| M³ | 50 MHz ≤ BW_{Channel}_{_{—}}_{CA} ≤ 200 | 3 | 3 |
| | MHz | | |
| N³ | 80 MHz ≤ BW_{Channel}_{_{—}}_{CA} ≤ 300 | 4 | |
| | MHz | | |
| O³ | 100 MHz ≤ BW_{Channel}_{_{—}}_{CA} ≤ 400 | 5 | |
| | MHz | | |

The UE may also report bandwidth combination sets using a supported bandwidth combination feature group. For instance, for a given band combination, the UE may report a supported bandwidth combination set. This field indicates the bandwidth combinations for an NR part of band combination. This field may be encoded as a bitmap, where a bit is set to 1 if the UE supports a corresponding bandwidth combination set for the associated band combination. Table 2 illustrates an example of an NR CA configuration and bandwidth combination set defined for intra-band contiguous CA.

TABLE 2
Example of NR CA configurations and bandwidth combination sets defined for intra-band contiguous CA
NR CA configuration/Bandwidth combination set

| | | | | | | | | |
|---|---|---|---|---|---|---|---|---|
| | Uplink CA | Channel | Channel | Channel | Channel | Channel | | |
| | configurations | bandwidths | bandwidths | bandwidths | bandwidths | bandwidths | Maximum | |
| | or single | for | for | for | for | for | aggregated | Bandwidth |
| NR CA | uplink | carrier | carrier | carrier | carrier | carrier | bandwidth | combination |
| configuration | carrier | (MHz) | (MHz) | (MHz) | (MHz) | (MHz) | (MHz) | set |

| | | | | | |
|---|---|---|---|---|---|
| CA_n41C | n41CA_n41C | 40 | 80, 100 | 180 | 0 |
| | | 50, 60, | 60, 80, | | |
| | | 80 | 100 | | |
| | | 10 | 100 | 190 | 1 |
| | | 15, 20 | 90, 100 | | |
| | | 40 | 80, 90, | | |
| | | | 100 | | |
| | | 50, 60, | 60, 80, | | |
| | | 80, 90 | 90, 100 | | |
| | | 10 | 100 | 190 | 2 |
| | | 15, 20 | 90, 100 | | |
| | | 30, 40 | 80, 90, | | |
| | | | 100 | | |
| | | 50, 60, | 60, 80, | | |
| | | 80, 90 | 90, 100 | | |

| | | |
|---|---|---|
| n41 channel | 190 | 4 and 5 |
| bandwidths for | | |
| each carrier | | |

Thus, for intra-band contiguous CA, a CA configuration may be a single operating band supporting a carrier aggregation bandwidth class with associated bandwidth combination sets. A UE may indicate support of several bandwidth combination sets per CA configuration. For intra-band non-contiguous carrier aggregation, a carrier aggregation configuration may be a single operating band supporting two or more sub-blocks, each supporting a carrier aggregation bandwidth class. For inter-band carrier aggregation, a carrier aggregation configuration may be a combination of operating bands, each supporting a carrier aggregation bandwidth class.

For a given band combination, the UE may also report a feature set combination, given by FeatureSetCombination. This information element may be a two-dimensional matrix of feature set entries. A feature set combination may indicate one or more feature sets per band, given by FeatureSetsPerBand. A feature set per band may indicate one or more feature sets. For instance, FeatureSetsPerBand may contain a list of feature sets applicable to the carrier(s) of one band entry of an associated band combination. A feature set, given by FeatureSet, may contain a pair of NR or E-UTRA feature set identifiers for uplink and downlink. The feature sets in this IE, FeatureSet, may respectively refer to actual feature sets defined in a different IE, given by FeatureSets. The feature sets in this different IE may also refer to uplink feature sets, given by FeatureSetUplink, and downlink feature sets, given by FeatureSetDownlink. For instance, FeatureSetUplink and FeatureSetDownlink may respectively indicate a set of features that the UE may support on carriers corresponding to one band entry in a band combination. These uplink and downlink feature sets, in turn, may indicate a number of carriers that the UE may aggregate contiguously in the frequency domain in a corresponding band, as given by FeatureSetUplinkPerCC-IDs and FeatureSetDownlinkPerCC-IDs, which number of carriers is restricted by an associated bandwidth class in an associated band combination. For instance, FeatureSetUplinkPerCC-IDs and FeatureSetDownlinkPerCC-IDs may respectively indicate a set of features that the UE may support on a corresponding carrier of one band entry of a band combination, such as a supported subcarrier spacing, supported bandwidth, channel bandwidth, maximum number of MIMO layers, a supported modulation order, or other features or capabilities. An example of FeatureSets is shown in Table 3, where each row indicates one set of capabilities that a UE may support across bands B1 and B2 in a given band combination. Thus, with the feature set combination IE, the UE may report different sets of capabilities for the same band combination.

TABLE 3
Example of Feature Sets for Bands B1 and B2

| BandCombo B1-B2 | B1 | B2 |
|---|---|---|
| FeatureSetsPerBand | FeatureSets #1 for B1 | FeatureSets #1 for B2 |
| FeatureSetsPerBand | FeatureSets #2 for B1 | FeatureSets #2 for B2 |

In 5G NR, for a given carrier or CC, different sets of RRC configuration parameters may be configured. One example includes serving cell common parameters, which may be applied to corresponding operations of a cell. For instance, the information element ServingCellConfigCommon may include serving cell common parameters. Such parameters may be commonly applied to multiple bandwidth parts of a cell, as they are assigned to the cell itself. Another example includes BWP-specific parameters, which may be set for individual BWPs on a given CC independently. For instance, the information elements BWP-DownlinkDedicated and BWP-UplinkDedicated may include BWP-specific parameters for individual downlink and uplink BWPs, respectively.

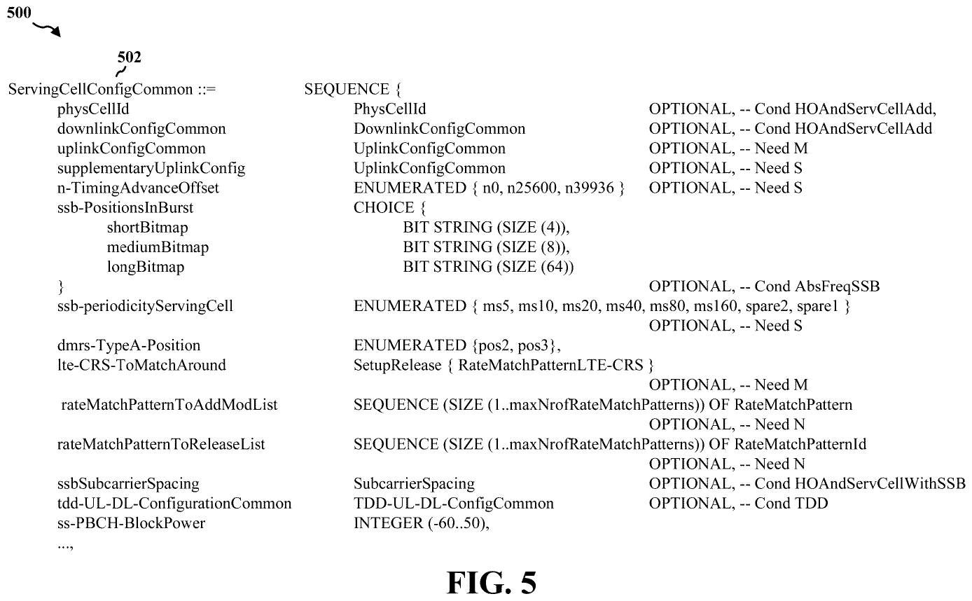

FIG. 5 illustrates an example 500 of an IE 502 including serving cell common parameters. This IE 502 may be used to configure cell specific parameters of a UE's serving cell, such as those illustrated but not limited to what is shown in the IE 502 of FIG. 5. The IE 502 contains parameters which a UE may acquire from a synchronization signal block (SSB), a master information block (MIB), or a system information block (SIB) when accessing the cell from an idle mode. The network may provide this information in dedicated signaling when configuring a UE with an SCell, with an additional cell group such as a secondary cell group (SCG), or for SpCells such as in a master cell group (MCG) and SCG upon reconfiguration with sync.

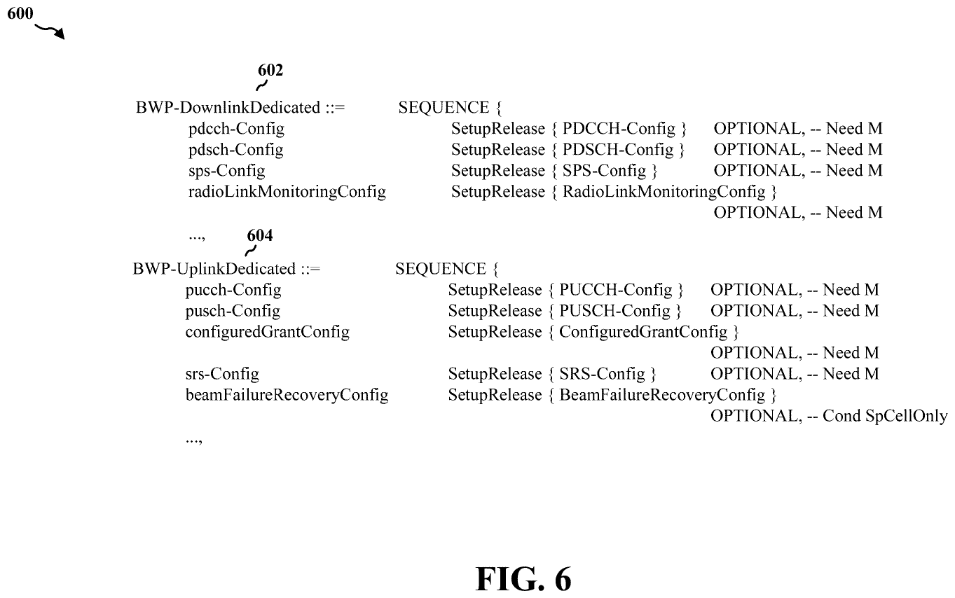

FIG. 6 illustrates an example 600 of IEs 602, 604 respectively including downlink and uplink BWP-specific parameters. The IE 602 may be used to configure dedicated or UE-specific parameters of a downlink BWP, such as those illustrated but not limited to what is shown in the IE 602 of FIG. 6. The IE 604 may be used to configure dedicated or UE-specific parameters of an uplink BWP, such as those illustrated but not limited to what is shown in the IE 604 of FIG. 6.

In carrier aggregation, a deactivated SCell may be activated in multiple manners. One example is direct SCell activation, which may occur at SCell addition. For instance, a UE may be configured in an RRC reconfiguration message with an SCell for which a corresponding parameter, such as sCellState, is set to activated. Alternatively, a UE may be configured in an RRC reconfiguration message with two or more SCells for which a corresponding parameter, such as sCellState, is set to activated. In such cases, the UE may configure the SCell or SCells in an activated state upon successful completion of an RRC reconfiguration procedure with a specified delay. In particular, the UE may transmit a valid CSI report and apply actions for a directly activated SCell no later than in slot

$$n + \frac{{N}_{d i r e c t}}{NR slot length}$$

in the case of a single SCell activation, or slot

$$n + \frac{{N}_{direct \_ multiple \_ scells}}{NR slot length}$$

in the case of multiple downlink SCell activation, where slot n is a last slot overlapping with a PDSCH containing the RRC reconfiguration message, N_{direct}=T_{RRC_Process}+T₁+T_{HARQ}+T_{activation_time}+T_{CSI_Reporting} for single SCell activation, and N_{direct_multiple_scells}=T_{RRC_Process}+T₁+T_{HARQ}+T_{activation_time_multiple_scells}+T_{CSI_Reporting} for multiple simultaneous SCell activation. Here, T_{RRC_Process} is a defined RRC procedure delay, which is typically 16 ms for RRC reconfiguration including SCell addition or release, T₁ is a delay from slot

$$n + \frac{{T}_{RRC \_ Process}}{NR slot length}$$

until the transmission of a RRC reconfiguration complete message, T_{HARQ} is a timing between downlink data transmission and acknowledgement (which may be replaced by −3 ms for cases where TCI state is not indicated within T_{activation_time}), T_{activation_time} is an SCell activation delay, T_{activation_time_multiple_scells} is a target SCell activation delay in multiple SCell activation scenario, T_{CSI_Reporting} is a delay associated with CSI reference resource acquisition and CSI reporting, and NR slot length is with respect to the numerology of the SCell(s) being activated. In either case, this RRC procedure delay or T_{RRC_Process} may be fixed to a defined value, such as 16 ms, regardless of the quantity of cells to be directly activated at a given time.

Alternatively to RRC-based, direct SCell activation, in which the UE activates an SCell without further indication than the RRC configuration, another example by which a deactivated SCell may be activated in carrier aggregation is MAC-CE based SCell activation. In MAC-CE based SCell activation, a MAC-CE indicates to the UE one or more configured SCells to be activated or deactivated. For instance, different fields within the MAC-CE may point to different CCs and indicate whether or not these CCs are activated.

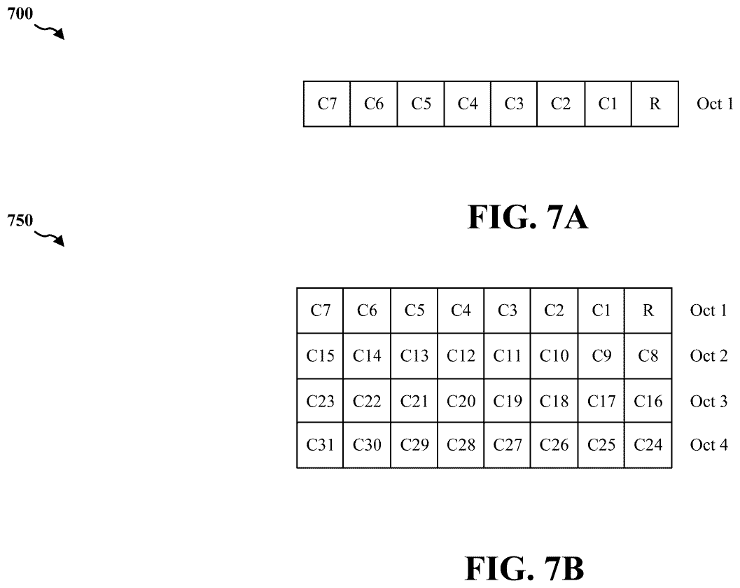

FIGS. 7A-7B illustrates examples of MAC-CEs 700, 750 for SCell activation and deactivation. MAC-CE 700 may be an SCell activation/deactivation MAC-CE of one octet that is configured to activate or deactivate up to eight SCells, while MAC-CE 750 may be an SCell activation/deactivation MAC-CE of four octets that is configured to activate or deactivate up to thirty-two SCells. In other examples, MAC-CEs may have different quantities of octets or be configured to activate and deactivate different quantities of SCells or other types of cells. In both examples, if a C field corresponding to an SCell configured with an SCell index is set to 1, the MAC-CE indicates that the corresponding SCell to that C field is to be activated. Alternatively, if the C field is set to 0, the MAC-CE indicates that the corresponding SCell is to be deactivated.

Another alternative to RRC-based direct SCell activation, as well as MAC-CE based SCell activation, is SCell activation via dormant BWP switching. A dormant BWP refers to a downlink BWP, configured by the network via dedicated RRC signaling, in which the UE stops monitoring PDCCH on or for the SCell, but may continue performing CSI measurements, automatic gain control (AGC) or beam management, if configured. Thus, a UE may perform certain operations such as channel measurement in a dormant BWP, but the UE may not receive or transmit data in such BWP. One or more BWPs in SCells may be configured in a dormant state. For instance, for a given SCell, a dormant BWP may be configured with a dormant BWP identifier (ID) by RRC signaling. Upon reception of a PDCCH indicating to enter a dormant BWP, the BWP indicated by the dormant BWP ID is activated. This PDCCH-based indication may be used to trigger a UE to switch from one of these dormant state BWPs or dormant BWPs to an activated, non-dormant state or non-dormant BWP, or vice-versa, similar to SCell activation or deactivation.

Currently, when SCells are configured, a UE may determine which BWP is the initial BWP on an SCell to be activated, such as via firstActiveDownlinkBWP-Id and firstActiveUplinkBWP-ID. However, there is no current ability for the UE to determine which of these SCells would be activated and when. Hence, the UE typically stores received configurations in a first memory, and once an activation command for the SCell is received, the UE fetches the corresponding configuration for processing. After parsing and processing the accessed configuration, the UE may store the processed configuration in a second memory. Such configuration accessing, parsing, and processing may add to the overall SCell activation latency.

Thus, it would be helpful for the UE to maintain a same or similar configuration across cells to leverage stored parameters and reduce SCell activation time. Aspects of the present disclosure accordingly provide for identical or similar cell-specific and BWP-specific RRC configurations, which sameness or similarity may be leveraged across carriers for efficient multi-carrier operation. As a result, memory requirements may be eased and SCell activation time may be reduced.

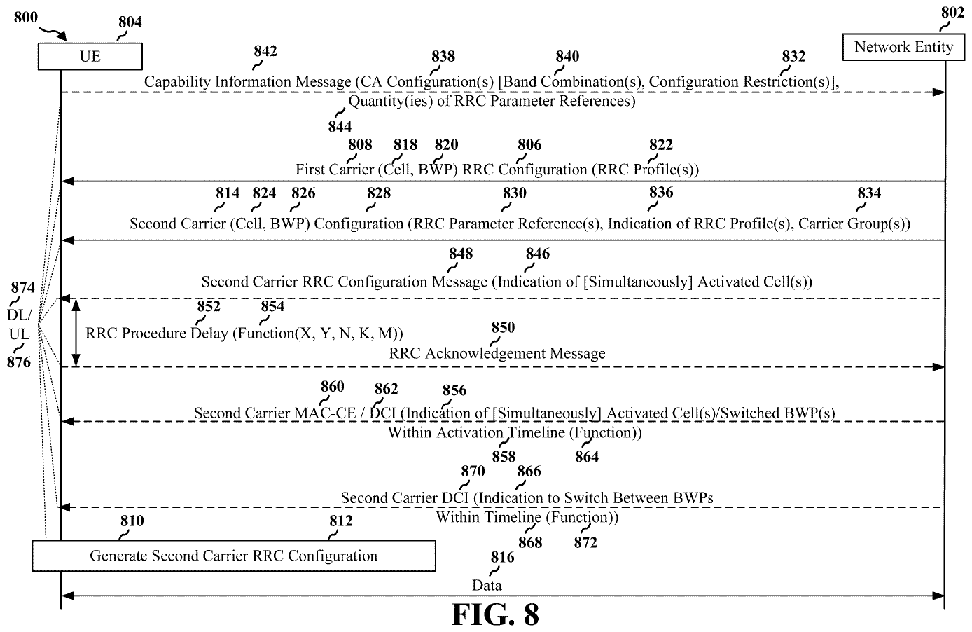

FIG. 8 illustrates an example 800 of a call flow between a network entity 802 and a UE 804. The network entity 802 may correspond to base station 102/180, disaggregated base station 181, a component of disaggregated base station 181 such as CU 183, DU 185, or RU 187, UE 104, or other network entity. In this example 800, a communication process between the network entity 802 and UE 804 is depicted illustrating various aspects of the present disclosure, which in general provide for the UE 804 to maintain identical or similar cell-specific and BWP-specific RRC configurations, such as those illustrated in FIGS. 5 and 6, across cells or BWPs, such as those illustrated in FIG. 4A or 4B. It should be understood while the following aspects specifically refer to examples including SCells, the aspects are not limited to SCells and may generally be extended to any type of cell.

In various aspects, UE 804 may obtain a first RRC configuration 806 associated with a first carrier 808, generate at block 810, at least in part from the first RRC configuration 806, a second RRC configuration 812 associated with a second carrier 814, and communicate data 816 with the network entity 802 over the first carrier 808 and the second carrier 814. The first carrier 808 may be associated with a first cell 818, a first BWP 820, or at least one RRC profile 822 respectively including a set of RRC parameters. For instance, the first carrier 808 may be a modulated waveform supported by a channel bandwidth configured in the uplink or downlink of the first cell 818, which bandwidth or serving cell may include one of multiple BWPs including the first BWP 820, and which cells or BWPs respectively are configured with one or more sets of cell-specific or BWP-specific RRC parameters included in RRC profile(s) 822. The second carrier 814 may be similarly associated with a second cell 824, a second BWP 826, or the at least one RRC profile 822. For instance, the second carrier 814 may be a modulated waveform supported by a channel bandwidth configured in the uplink or downlink of the second cell 824, which bandwidth or serving cell may include one of multiple BWPs including the second BWP 826, and which cells or BWPs respectively are configured with one or more sets of cell-specific or BWP-specific RRC parameters included in RRC profile(s) 822. Thus, sameness or similarity of configuration may be leveraged across carriers for efficient multi-carrier operation, easing memory requirements and reducing SCell activation time.

In one aspect, the UE 804 may obtain a configuration 828 indicating one or more RRC parameter references 830 for the second carrier 814, where the second RRC configuration 812 is at least partially generated at block 810 from at least a portion of RRC parameters associated with the one or more RRC parameter references 830. More particularly, in this aspect, common or similar RRC parameter settings for respective configured SCells may be devised based on different levels of RRC signaling for these cells. For instance, respective configured SCells may be indicated in configuration 828 with one or more different RRC parameter references 830, where a given reference provides a full or partial set of RRC setting(s) for the corresponding SCell. For instance, a respective RRC parameter reference may provide either a full set or a subset of RRC setting(s) for an SCell, including cell-specific parameters such as shown in FIG. 5 or BWP-specific parameters such as shown in FIG. 6, such that the SCell may be said to “borrow” these parameters of the reference. As an example, the serving cell common configuration parameters for an SCell, or the BWP-specific configuration parameters for a BWP in that SCell, may be obtained, or borrowed, from those of another SCell or BWP, respectively. Similarly, a portion of serving cell common configuration parameters for an SCell, or a portion of BWP-specific configuration parameters for a BWP in that SCell, may be obtained, or borrowed, from those of another SCell or BWP, respectively, while a remainder of the parameters for the borrowing SCell or BWP may be received in a network configuration. Such other SCell or BWP, from which a given SCell or BWP's parameters are borrowed, is referred to as an RRC parameter reference for the given SCell or BWP. Moreover, an SCell for which a cell-specific or BWP-specific RRC configuration is fully or partially borrowed from that of another SCell or DL or UL BWP, is referred to as an SCell or BWP with a configuration restriction 832 or an RRC restriction. Other SCells or BWPs which RRC configurations are obtained without the aforementioned borrowing are respectively referred to as an SCell or BWP lacking a configuration restriction or without an RRC restriction. Thus, RRC parameter reference 830 may be an SCell or BWP lacking configuration restriction 832.

In one aspect, the one or more RRC parameter references 830 may include a first RRC parameter reference associated with common serving cell parameters for the first cell 818 and a second RRC parameter reference associated with BWP-specific parameters for the first BWP 820, and the second RRC configuration 812 is at least partially generated at block 810 from the common serving cell parameters or the BWP-specific parameters. Thus, a respective configured SCell may have multiple RRC parameter references 830. For instance, a first set of references may be configured to indicate a full set or a partial set of serving cell common RRC configuration parameters of a intended serving cell or SCell such as shown in FIG. 5, while a second set of references may be configured to indicate a full set or a partial set of DL or UL BWP-specific RRC configuration parameters of a downlink or uplink BWP for that intended serving cell or SCell such as shown in FIG. 6. In one example, the one or more RRC parameter references 830 may include a plurality of RRC parameter references associated with different common serving cell parameters for different cells including the first cell 818, and the second RRC configuration 812 may be fully generated at block 810 from the RRC parameter references. For instance, with respect to the first set of references, in the case of a partial RRC configuration indication, the RRC setting for the intended SCell may be borrowed from multiple RRC parameter references to generate the full set of RRC configuration parameters for the intended SCell. Similarly, in another example, the one or more RRC parameter references 830 may include a plurality of RRC parameter references associated with different BWP-specific parameters for different BWPs including the first BWP 820, and the second RRC configuration 812 may be fully generated at block 810 from the RRC parameter references. For instance, with respect to the second set of references, in the case of a partial RRC configuration indication, the DL and UL BWP RRC configuration parameters in the intended SCell may be generated from multiple RRC parameter references. Additionally or alternatively, the RRC parameter reference(s) for DL and UL BWPs may be the same reference(s) or different references.

In one aspect, the UE 804 may obtain configuration 828 including RRC parameter reference 830 for the second carrier 814, the RRC parameter reference indicating one of: the first cell 818, where the first cell 818 is an activated cell including common serving cell parameters such as shown in FIG. 5, or the first BWP 820 configured for the first cell 818, wherein the first BWP 820 is an activated BWP or a deactivated BWP including BWP-specific parameters such as shown in FIG. 6. In such case, the second RRC configuration 812 may be at least partially generated at block 810 from at least a portion of the common serving cell parameters or the BWP-specific parameters. More particularly, in this aspect, cell-specific, DL BWP-specific, and UL BWP-specific RRC configurations may be provided for a configured SCell that is being activated or not yet activated. Thus, in the case where an RRC parameter reference is for borrowing a cell common RRC configuration, the RRC parameter reference for a given intended SCell may refer to a previously activated cell. For example, if a UE is configured with two serving cells, cell 1 and cell 2, where cell 1 is already activated and cell 2 is to be activated, then cell 1 may serve as an RRC parameter reference to cell 2. That is, cell 2 may apply the cell common RRC configuration of cell 1. Similarly, in the case where the RRC parameter reference is for borrowing a BWP-specific RRC configuration, the RRC parameter reference may refer to a previously activated or configured DL BWP or UL BWP on a previously activated SCell. For example, if a UE is configured with multiple DL and UL BWPs in cell 1, where only one of these BWPs is active at a given time, then one of these active BWPs may serve as an RRC parameter reference for a BWP in cell 2. Alternatively, the RRC parameter reference for the BWP in cell 2 may refer to any of the configured, activated, or deactivated, DL or UL BWPs in cell 1, as opposed to merely the currently active DL or UL BWP in cell 1. Thus, in this example, the RRC parameter reference may be a cell for cell-specific parameters, or a BWP associated with a cell for BWP-specific parameters. Moreover, the BWP associated with a to-be-activated cell may be associated with cell reference, or in other words, a cell may be an RRC parameter reference for a BWP in a different cell. For example, if cell 1 serves as an RRC parameter reference to cell 2, then a BWP-specific configuration for cell 2 may have same or similar parameters as the first active DL BWP or first active UL BWP in cell 1.

In one example of this aspect, the second RRC configuration 812 may at least be partially generated for the second BWP 826 from the BWP-specific parameters associated with the first BWP 820, the second BWP 826 being an initially activated BWP for the second cell. For instance, in this example, for a downlink or uplink BWP, the first BWP to activate on an intended SCell may have its RRC configuration borrowed from one or more other activated or possibly deactivated DL or UL BWPs on other previously activated cell(s) including PCells or SCells. For example, the initial BWP to be activated for cell 2 may obtain its BWP-specific configuration from, and thus use the same parameters as, a reference DL or UL BWP on cell 1.

In another example of this aspect, the RRC parameter reference 830 may be configured for respective ones of a plurality of carriers including the second carrier 814. For instance, in another example, a single reference cell or DL or UL BWP may be defined for multiple configured CCs. For example, the same RRC parameter reference may be applied for each CC in FIG. 4A or 4B.

In another example of this aspect, different ones of a plurality of RRC parameter references 830 including the RRC parameter reference may be respectively configured for different groups 834 of carriers including the second carrier 814. For instance, in another example, multiple reference cells or DL or UL BWPs may be defined for different groups of CCs. For example, one RRC parameter reference may be applied for one group of CCs and a different RRC parameter reference may be applied for another group of CCs in FIG. 4A or 4B.

In one aspect, the group 834 for the second carrier 814 may be indicated in a semi-static configuration or a dynamic configuration. For example, this CC grouping for reference purposes may be indicated semi-statically or dynamically. For instance, in the semi-static example, the network may provide an RRC configuration indicating that CC1 is grouped with CC2 or that CC1 is in a different group than CC2 for reference purposes, such as configuration 828. Alternatively, in the dynamic example, the network may provide a MAC-CE or DCI indicating which CCs are in which group(s).

In one aspect, carriers in the group 834 including the second carrier 814 may be associated with a same cell group, a same PUCCH group, a same carrier frequency band, or a same carrier frequency range. For instance, a CC grouping for reference purposes may be defined based on cell grouping. In one example, CCs in a MCG may be grouped together, while CCs in a SCG may be grouped together. In another example, a CC grouping for reference purposes may be defined based on PUCCH groups. For instance, CCs with HARQ-ACK feedback on a PCell may be grouped together, while CCs with HARQ-ACK feedback on a secondary PUCCH cell may be grouped together. In another example, a CC grouping for reference purposes may be based on the band(s) and frequency range(s) in which the CCs are located. For instance, intra-band CCs may have a reference CC in a same band, since these CCs may experience same or similar levels of channel conditions or interference conditions. As an example of this, if a band includes three contiguous carriers, one of which is activated, then the activated CC may serve as an RRC parameter reference for the two non-activated CCs in the same band. Alternatively, the reference here may not necessarily be an activated cell but a de-activated cell, and the other CCs may still borrow their RRC parameters from those configured for the deactivated reference carrier. Thus, in a given band, one CC may be configured via an explicitly indicated RRC configuration, while one or more other CCs in the same band may have their RRC configurations generated using the RRC configuration of the reference CC or DL or UL BWP in the same band. The explicitly configured CC may thus serve as an RRC parameter reference for the other CC(s), without itself having its own RRC parameter reference. Any combination of the aforementioned examples may be applied.

In one aspect, UE 804 may obtain an indication 836 of the at least one RRC profile 822 for the second carrier 814, the second RRC configuration 812 for the second cell 824 or the second BWP 826 being generated at block 810 at least partially from the at least one RRC profile 822 in response to the indication 836. For instance, a UE may be configured with a set of RRC parameters, or one or more RRC profiles 822, which the base station may provide to the UE, for example, once the UE enters an RRC connected mode. Respective to-be-activated SCells and downlink and uplink BWPs may then be indicated to use one or more of these RRC profiles to generate a full RRC configuration for those cell(s) or BWP(s). For instance, multiple RRC profiles may be defined which respectively include a set or subset of serving cell common configuration parameters or BWP-specific parameters, and the UE may be indicated to apply one or more of these profiles for a cell or BWP. Thus, the base station may indicate to the UE that a given RRC profile(s) is activated for use with a respective SCell or BWP. Moreover, similar to the aforementioned RRC parameter references, one or more RRC profile(s) may be shared between different CCs, such that a same or different RRC profiles may be configured for multiple cells or BWPs. Thus, an RRC profile may also serve as an RRC parameter reference, similar to a cell or BWP, if it is commonly applied to other carriers.

In one aspect, the configuration 828 including the RRC parameter reference 830 for the second carrier 814 may be one of: a semi-static configuration for the second cell 824, or a dynamic configuration activating the second cell 824. For instance, a reference for a given intended SCell may be defined and indicated in a semi-static manner or a dynamic manner. In one example, under a semi-static indication, a respective SCell being activated may be configured via RRC, such as part of an SCell configuration, with a reference for serving cell-specific or for DL or UL BWP-specific RRC configurations. For instance, when the base station configures an SCell with an SCell configuration, the SCell configuration may indicate the RRC parameter reference for that SCell to be applied when the SCell is activated. The RRC parameter reference may be another cell, a BWP, or an RRC profile. In one example, under a dynamic indication, an activation command such as a MAC-CE or DCI may indicate which other activated SCell(s) or activated DL or UL BWP(s) may be used to form an RRC configuration for the intended cell. For instance, the MAC-CE or DCI may indicate an activated cell, or an activated or non-activated BWP, which may be used as a reference for generating an RRC configuration for an intended cell or BWP.

Similarly, in one aspect, the indication 836 of the at least one RRC profile 822 may be included in a semi-static configuration for the second cell 824 or a dynamic configuration activating the second cell 824. In one example, under a semi-static indication, if RRC profiles are previously configured, a respective to-be-activated SCell may be configured with its corresponding RRC profile(s). For instance, if the base station indicates one of multiple defined RRC profiles to the UE, this indicated RRC profile may correspond to a to-be-activated SCell which the UE may apply to generate a cell-specific or BWP-specific configuration for that SCell. In another example, under a dynamic indication, if RRC profiles are previously configured, an activation command such as a MAC-CE or DCI may indicate one or more RRC profiles to be used for the intended SCell. For instance, the MAC-CE or DCI may indicate a set of RRC profiles from which the UE may generate a cell-specific or BWP-specific configuration for the intended cell or BWP.

Thus, in the aforementioned examples, the SCell configuration or a MAC-CE or DCI that activates an SCell or BWP may indicate, for example, using a pointer, an RRC parameter reference such as a cell, BWP, or RRC profile, which reference cell-specific or BWP-specific configuration(s) is to be used to generate the RRC configuration for the activated SCell or BWP. The RRC configuration for a semi-statically or dynamically activated SCell or BWP may be considered here a “thin” or light RRC configuration, since one or more of its parameters may be referenced or borrowed from an RRC configuration of a different indicated cell or indicated BWP, or from an indicated RRC profile, rather than be explicitly indicated in the RRC configuration itself. For instance, a semi-static or dynamic indication of SCell activation may point to another cell, indicating the UE to borrow the parameters of this reference cell for its activated cell or BWP, or it may point to one of multiple RRC profiles, indicating the UE to apply for example the parameters of indicated profile X to its activated cell or BWP. Likewise, a thin or light SCell configuration, with only a subset of explicitly indicated parameters for a configured but not activated SCell, may include a field that indicates a pointer to a configuration the UE may apply to fill out the rest of the configuration's parameters when the SCell is to be semi-statically or dynamically activated. This pointer may refer to a cell, a BWP, an RRC profile, or other RRC parameter reference.

Accordingly, by using thin RRC configurations, UEs may achieve higher envelopes, or in other words support larger numbers of CCs, by relaxing their memory requirement or achieving faster SCell activation. For instance, the UE may not need to repeat storage and processing of an RRC configuration for each CC, such as for respective ones of ten carriers in FR2, but the UE may instead store and process fewer copies of this RRC configuration since the others may be borrowed from the reference configurations. This allows for the UE's memory requirement for configurations to not have to scale with the number of supported CCs, allowing the UE to support larger numbers of CCs such as twelve carriers in FR2 for example. To these ends, various UE capabilities may be defined which the UE may report in connection with CA configurations 838 and band combinations 840 such as previously described in connection with Tables 1, 2, and 3. For instance, a UE may report two sets of CA capabilities, one with an assumption that the configurations are independently indicated, and one with an assumption that one or more CCs may borrow a full or partial set of configurations from one or more other reference CCs. For example, a UE may indicate in one set of capabilities that it can support 4 CCs with total of 200 MHz in band 1 if three of these CCs borrow their RRC configuration from the reference CC, and the UE may indicate in another set of capabilities that it can support 2 CCs with a 100 MHz total BW otherwise.

In one aspect, the UE 804 may send a capability information message 842 indicating a first CA combination for the first carrier 808 and a second CA combination for the second carrier 814, the first CA combination including a first band combination lacking configuration restriction 832 based on RRC parameter reference 830, and the second CA combination including a second band combination having the configuration restriction 832 based on the RRC parameter reference 830. CA combinations may include, for example, be or correspond to, CA configurations 838 or band combinations 840, one or more band combinations 840 of CA configuration 838, one or more CA configurations 838 of band combination 840, a combination of bands or carriers associated with one or more CA configurations, or the like. For instance, when reporting support of downlink or uplink carrier aggregation, the UE may provide multiple sets of capabilities. In one example, in a given band combination, the UE may report the CA configurations 838 it supports without configuration restriction 832, including the bandwidth class per band or segment of a band in case of non-contiguous intra-band CA, such as the number of CCs and total bandwidth supported. Similar to that described before, here a CA configuration lacking configuration restriction 832 or without RRC restriction refers to a CA configuration including carriers or bands that do not borrow their RRC configuration from other references, such as CA configurations 838 associated with cells or BWPs which serve as RRC parameter references 830 themselves and which have RRC configurations that are explicitly configured. In another example, in a given band combination, the UE may report the CA configurations it supports with configuration restriction 832. Similar to that described before, here a CA configuration having a configuration restriction or with RRC restriction refers to a CA configuration including carriers or bands that do borrow their RRC configuration from other references, such as CA configurations associated with cells or BWPs which configurations are generated based on RRC parameter references and thus have thin or light RRC configurations. In a further example, the capability information message 842 may further indicate a third CA combination, the third CA combination including the second band combination having a different configuration restriction based on an RRC parameter reference. For instance, the CA configurations 838 the UE supports with configuration restriction 832 may be reported multiple times with different restrictions. For example, the UE may report a supported CA configuration indicating an RRC restriction in one band but lacking an RRC restriction in another band, indicating an RRC restriction in both bands, or the like. Thus, the UE 804 may report the different capabilities it has for carrier aggregation via configuration restriction 832 or lack of configuration restriction 832. As an example, if the UE is capable of supporting ten carriers in FR2 when they lack configuration restriction, but the UE is capable of supporting twelve carriers in FR2 when at least some of these CCs have configuration restriction, the base station may ascertain these different capabilities of the UE for CA in its report.

In one aspect, the capability information message 842 may further indicate a quantity 844 of RRC parameter references 830 associated with a band combination, a band in the band combination, or the band. More particularly, the UE 804 may report a capability indicating a number of reference cells or downlink or uplink BWPs it supports. For instance, the UE may report a quantity of supported cells or supported BWPs that lack configuration restriction 832 or which may serve as RRC parameter references 830. This quantity may determine the memory requirement of the UE, which may scale with the number of supported CCs. In one example, this reported capability may be per band combination 840, per band in a band combination, separately per downlink or uplink feature set, or per band. For instance, a same quantity or a different or independent quantity of supported cells or supported BWPs that lack configuration restriction may be reported for respective band combinations, bands in a band combination, feature sets, or bands. Alternatively or additionally, the capability information message 842 may further indicate a same quantity 844 of RRC parameter references 830, or different quantities 844 of the RRC parameter references 830, respectively associated with one or more of: the at least one RRC profile 822, a semi-static configuration for the second cell 824 that includes an RRC parameter reference, or a dynamic configuration activating the second cell 824 that includes the RRC parameter reference. More particularly, this reported capability may be the same, or independent, for previously configured RRC profiles, semi-static indication of references, or dynamic indication of references. For instance, a same quantity or a different or independent quantity of supported cells or supported BWPs that lack configuration restriction may be reported for respective RRC profiles, semi-statically indicated references, or dynamically indicated references.

In one aspect, a timeline for direct SCell activation may be based on one or more of the aforementioned aspects of thin RRC configurations. For example, generally, an RRC processing or procedure delay for direct SCell activation, such as that previously described and indicated by T_{RRC_Process}, may not change based on a number of SCells to be directly activated simultaneously. For instance, as previously described, the RRC procedure delay for SCell addition or release may be a fixed 16 ms, regardless of how many SCells are activated simultaneously at a given time. In other words, the delay does not scale with quantity of CCs, which may be problematic in some 5G implementations. Therefore, in this aspect, the RRC processing delay may instead be configured to scale with the number of CCs to be directly activated. For instance, the aforementioned 16 ms delay may change depending on how many SCells are activated simultaneously at a given time. Moreover, the RRC procedure delay may change further depending on whether these SCells have or lack configuration restriction, as previously described with respect to thin RRC configurations.

Thus, in this aspect where an RRC processing delay, such as T_{RRC_Process}, scales with a quantity of simultaneously to-be-activated CCs for direct SCell activation, the RRC processing delay may be defined in one of multiple manners. This aspect applies to direct cell activation cases, where the UE 804 may obtain an indication 846 in an RRC configuration message 848 to activate a cell, or simultaneously activate a plurality of cells, respectively lacking or having configuration restriction 832 based on RRC parameter reference 830, and may send an RRC acknowledgment message 850 in response to the RRC configuration message 848. Here, the activated cell(s) may include the second cell 824 or some other cell(s), such as a third cell and a fourth cell, corresponding to different ones of the CCs illustrated in FIG. 4A or 4B.

In one example, an RRC procedure delay 852 (T_{RRC_Process}) associated with the obtaining of the RRC configuration message 848 and the sending of the RRC acknowledgment message 850 may be a time (X). More particularly, the RRC processing delay 852 may be a fixed quantity X in milliseconds (ms) or other unit of time for single cell direct activation without RRC constraints. For instance, if one cell is to be directly activated via an RRC configuration, the delay associated with activation of that cell may be a fixed value X, such as 16 ms for T_{RRC_Process}.

In another example, the RRC procedure delay 852 associated with the obtaining of the RRC configuration message 848 and the sending of the RRC acknowledgment message 850 may be a function 854 of a time (X) and a quantity of the cells (N) indicated as simultaneously activated in the RRC configuration message 848. For instance, the RRC processing delay may a product of the fixed quantity X and a quantity N of SCells to be configured and directly activated simultaneously. For example, if N cells are to be directly activated via an RRC configuration, the delay associated with simultaneous activation of those cells may be X*N in ms or other unit of time. Thus, the time delay X may be scaled by N cells, since the N cells respectively lack configuration restriction.

In a further example, the RRC procedure delay 852 associated with the obtaining of the RRC configuration message 848 and the sending of the RRC acknowledgment message 850 may be the function 854 of a time (X) and a difference between a quantity of at least one cell (N) lacking the configuration restriction 832 and a quantity of at least one cell (K) having the configuration restriction 832. For instance, the RRC processing delay 852 may be a product of the fixed quantity X and a difference between: the quantity N of SCells to be configured and directly activated simultaneously and a quantity K SCells which borrow their RRC configuration from other reference(s). For example, if N cells are to be directly activated via an RRC configuration, and K of these N cells have a configuration restriction, then the delay associated with simultaneous activation of these cells may be X*(N−K) in ms or other unit of time. Thus, the time delay X may be scaled by (N−K) cells, since the K cells respectively have configuration restrictions while N−K cells respectively lack configuration restrictions.

Thus, different activation timelines may occur depending on the number of carriers which serve as RRC parameter references or not. The activation timeline for simultaneously activated SCells may scale up with the number of cells that lack RRC restriction, but may not scale up with the number of cells that have RRC restriction. Thus, latency associated with direct SCell activation may be reduced.

In the above examples, the RRC procedure delay 852 for cells having the configuration restriction is zero. More particularly, it is assumed that the RRC processing delay, such as T_{RRC_Process}, for single cell direct activation with RRC borrowing is zero. That is, the different timing examples for T_{RRC_Process} of X, X*N, or X*(N−K) respectively assume that there is no or zero RRC processing time or delay for cells having configuration restriction, such as the K cells. However, in some cases, the RRC processing delay even for cells having configuration restriction may be nonzero. In such case, at least some of the aforementioned timing examples may be modified.

Thus, in this aspect where RRC procedure delay 852, such as T_{RRC_Process}, scales with a quantity of to-be-activated CCs for direct SCell activation, but the RRC procedure delay 852 for cells having configuration restriction 832 is nonzero, the RRC procedure or processing delay may be differently defined in one of multiple manners. This aspect similarly applies to direct cell activation cases, where the UE 804 may obtain indication 846 in RRC configuration message 848 to activate a cell, or simultaneously activate a plurality of cells, respectively lacking or having configuration restriction 832 based on RRC parameter reference 830, and may send RRC acknowledgment message 850 in response to the RRC configuration message 848. Likewise here, the activated cell(s) may include the second cell 824 or some other cell(s), such as a third cell and a fourth cell, corresponding to different ones of the CCs illustrated in FIG. 4A or 4B.

In one example, the RRC procedure delay 852 associated with the obtaining of the RRC configuration message 848 and the sending of the RRC acknowledgment message 850 may be a time (X) for cells lacking the configuration restriction 832. For instance, the RRC processing delay may be a fixed quantity X in milliseconds (ms) or other unit of time for single cell direct activation without RRC constraints. For example, if one cell lacking configuration restriction is to be directly activated via an RRC configuration, the delay associated with activation of that cell may be a fixed value X, such as 16 ms for T_{RRC_Process}. The difference between this example and the previous identical example is that here, X is specifically the delay associated with to-be-activated cells lacking RRC restriction, as opposed to cells activated in general.

In another example, the RRC procedure delay 852 associated with the obtaining of the RRC configuration message 848 and the sending of the RRC acknowledgment message 850 may be a nonzero time (Y) for cells having the configuration restriction 832. For instance, the RRC processing delay may be a fixed quantity Y in milliseconds (ms) or other unit of time for single cell direct activation with RRC restriction. For example, if one cell having configuration restriction is to be directly activated via an RRC configuration, the delay associated with activation of that cell may be a fixed value Y, such as a lesser value than 16 ms for T_{RRC_Process} such as 5 ms.

In another example, the RRC procedure delay 852 associated with the obtaining of the RRC configuration message 848 and the sending of the RRC acknowledgement message 850 may be the function 854 of a time (X) for cells lacking the configuration restriction 832 and a quantity of the cells (N) indicated as simultaneously activated in the RRC configuration message 848. For instance, the RRC processing delay for cells lacking configuration restriction may a product of the fixed quantity X and a quantity N of SCells to be configured and directly activated simultaneously. For example, if N cells lacking configuration restriction are to be directly activated via an RRC configuration, the delay associated with simultaneous activation of those cells may be X*N in ms or other unit of time.

In another example, the RRC procedure delay 852 associated with the obtaining of the RRC configuration message 848 and the sending of the RRC acknowledgement message 850 may be the function 854 of a nonzero time (Y) for cells having the configuration restriction 832 and a quantity of the cells (M) indicated as simultaneously activated in the RRC configuration message 848. For instance, the RRC processing delay may a product of the fixed quantity Y and a quantity M of SCells to be configured and directly activated simultaneously. For example, if M cells having configuration restriction are to be directly activated via an RRC configuration, the delay associated with simultaneous activation of those cells may be Y*M in ms or other unit of time.

In another example, the RRC procedure delay 852 associated with the obtaining of the RRC configuration message 848 and the sending of the RRC acknowledgement message 850 may be the function 854 of a time (X) for cells lacking the configuration restriction 832, a quantity of the at least one third cell (N) lacking the configuration restriction 832, a nonzero time (Y) for cells having the configuration restriction 832, and a quantity of the at least one fourth cell (M) having the configuration restriction 832. For instance, the RRC processing delay for cell activation may a sum of: a first product of the fixed quantity X and a quantity N of SCells to be configured and directly activated simultaneously, and a second product of the fixed quantity Y and a quantity M of SCells which borrow RRC configuration(s) from other references. For example, if N cells lacking configuration restriction and M cells having configuration restriction are to be directly activated via an RRC configuration, the delay associated with simultaneous activation of those cells may be X*N+Y*M in ms or other unit of time.

Similar aspects as previously described for direct SCell activation may be applied to dynamic SCell activation, including MAC-CE based SCell activation and dormant BWP switching. For instance, there are portions of the overall cell or BWP activation timelines where in some cases a UE may fetch stored RRC configurations and process them. For example, in MAC-CE based SCell activation, after the base station provides the UE a MAC-CE or other indication to activate an SCell, a UE may fetch and process RRC configurations during a 3 ms MAC-CE processing delay in which the UE completes MAC-CE processing and completes the SCell activation. The MAC-CE processing delay may be different than 3 ms in other examples. In another example, after the UE receives and acknowledges a MAC-CE for SCell activation, or in response to a DCI triggering a switch from a dormant BWP to an active BWP, the UE may fetch and process RRC configurations during a software delay margin accounting for delays involving software for RF and baseband. Such delays associated with RRC configuration fetching and processing in SCell and BWP activation timelines may result in similar latency concerns that would otherwise be resolved using thin RRC configurations. Moreover, similar to the direct SCell activation case, in these cases the activation timelines may likewise be dependent on a quantity of CCs that are being simultaneously activated. Therefore, it would be helpful to extend the above-described aspects of direct SCell activation based on the thin RRC concept similarly to MAC-CE or dormant BWP-based activation for similar latency reduction. In this way, the cell activation latency may be reduced for different activation mechanisms, although the actual reduction in latency could be dependent on the scheme used, such as RRC based activation, MAC-CE based activation or dormant BWP based activation.

Thus, these aspects may be extended to cases where the UE 804 obtains an indication 856 to activate a cell, or to simultaneously activate cells, having or lacking configuration restrictions 832 based on RRC parameter reference(s) 830, within an activation timeline 858, such as a timeline for MAC-CE based SCell activation or a timeline for dormant BWP switching. Here, the indication 856 may be obtained in one of: a MAC-CE 860, such as illustrated in FIG. 7A or 7B, or DCI 862 triggering a switch from a dormant state BWP to a non-dormant state BWP. The activated cell(s) here may include the second cell 824 or some other cell(s), such as a third cell and a fourth cell, corresponding to different ones of the CCs illustrated in FIG. 4A or 4B.

In one aspect, the activation timeline 858 may be a function 864 of whether the cell has configuration restriction 832 based on RRC parameter reference 830. For instance, the latency requirement for a single cell activation based on MAC-CE 860, or based on DCI 862 via dormant BWP to non-dormant BWP switching, may depend on whether or not an SCell RRC configuration associated with the cell or BWP is restricted to be similar or the same as another reference. For example, any activation timeline for single SCell activation based on MAC-CE or BWP switching based on DCI may be based on whether the cell or BWP(s) have a configuration restriction or borrow parameters from an RRC parameter reference. As an example, the MAC-CE processing delay associated with MAC-CE based activation or the software delay margin associated with MAC-CE based activation or dormant BWP switching may be different for different cells depending on whether or not the cell lacks RRC configuration restriction, with the delay being modified in a similar manner as that described with respect to direct SCell activation. For instance, paralleling delays X and Y for direct SCell activation, similar delays X′ and Y′ may occur here, where X′ is the MAC-CE processing delay or software delay margin for cells lacking RRC restriction, and Y′ is a shorter delay for cells having RRC restriction.

Similarly, in another aspect, the activation timeline 858 may be the function 864 of a quantity of the at least one cell lacking the configuration restriction 832 and a quantity of the at least one cell having the configuration restriction 832. For instance, for multiple SCell activation based on MAC-CE 860, or based on DCI 862 via dormant BWP to non-dormant BWP switching, the total latency requirement may depend on a quantity of CCs being activated simultaneously for which the RRC configuration is restricted and the quantity of CCs for which the RRC configuration lacks restriction. For example, any activation timeline for simultaneous multiple SCell activation based on MAC-CE or BWP switching based on DCI may be based on how many cells or BWP(s) have a configuration restriction or borrow parameters from an RRC parameter reference, and how many cells or BWP(s) lack such configuration restriction or themselves serve as RRC parameter references. As an example, the MAC-CE processing delay associated with MAC-CE based activation or the software delay margin associated with MAC-CE based activation or dormant BWP switching may be different for different cells depending on how many cells have and lack RRC configuration restriction. For instance, paralleling delays X and Y and CC quantities N and M for direct SCell activation, a similar delay X′ and Y′ and a similar quantity of CCs N′ and M′ may occur here, where X′ is the MAC-CE processing delay or software delay margin for cells lacking RRC restriction, Y′ is a shorter delay for cells having RRC restriction, N′ is a number of simultaneously activated cells lacking configuration restriction, and M′ is a number of simultaneous cells having configuration restriction.

In regard to SCell activation capabilities, the aforementioned capability aspects related to thin RRC configurations may be extended to direct SCell activation and dynamic SCell activation.

One aspect may apply in the case when the UE 804 obtains indication 846 in RRC configuration message 848 to activate at least one cell lacking or having configuration restriction 832 based on RRC parameter reference 830, and sends RRC acknowledgment message 850 in response to the RRC configuration message 848. Here, the RRC procedure delay 852 associated with the obtaining of the RRC configuration message 848 and the sending of the RRC acknowledgment message 850 is the function 854 of at least one of the time (X) or nonzero time (Y) for cells respectively lacking or having configuration restriction 832. In such case, at least one of the time (X) or the nonzero time (Y) may be fixed or indicated as a UE capability, the UE capability being per UE, per band, per bandwidth class, per band in band combination, per downlink feature set, or per uplink feature set. For instance, for the case of direct SCell activation, the aforementioned time delays X and Y in connection with RRC procedure delays such as T_{RRC_Process} may be defined in fixed manner, such as via hard-coding in a specification, or reported as a UE capability. In the case where the delays X and Y are reported as UE capabilities, these capabilities may be reported per UE, per band, per band combination, per band in a band combination (BoBC), per downlink or uplink feature set, or any combination of the foregoing.

Another aspect may apply in the case when the UE 804 obtains indication 856 in MAC-CE 860 or DCI 862 to activate, within activation timeline 858, at least one cell lacking or having configuration restriction 832 based on RRC parameter reference 830. Here, the activation timeline 858 is the function 864 of one or more of whether the cell has configuration restriction 832 based on RRC parameter reference 830 or a quantity of cell(s) lacking or having configuration restriction 832, and the activation timeline 858 further includes the time (X) or nonzero time (Y) for cells respectively lacking or having configuration restriction 832. In such case, at least one of the time (X) or the nonzero time (Y) may be fixed or indicated as a UE capability, the UE capability being per UE, per band, per bandwidth class, per band in band combination, per downlink feature set, or per uplink feature set. For instance, for the case of dynamic SCell activation, either by MAC-CE or DCI via BWP switching, the overall SCell activation latency may depend on whether the RRC configuration of an SCell being activated is borrowed from other reference(s), a quantity of simultaneous SCells being activated with RRC restriction, and a quantity of simultaneous SCells being activated without RRC restriction. These latencies may respectively correspond to X′/Y′, M′, and N′ as previously described. Moreover, these latencies may similarly be reported as UE capabilities per UE, per band, per band combination, per BoBC, per downlink or uplink feature set, or any combination of the foregoing. For example, the aforementioned parallel delays X′, Y′ and the aforementioned parallel CC quantities N′, M′ may be fixed or reported as UE capabilities according to any combination of the foregoing.

The aforementioned aspects on SCell activation via dormant to non-dormant BWP switching may be extended in general to BWP switching, such as from one active BWP to another active BWP. In one aspect, the UE 804 may obtain an indication 866 to switch, within a timeline 868, between at least one BWP lacking configuration restriction 832 based on RRC parameter reference 830 and at least one BWP having the configuration restriction 832 based on the RRC parameter reference 830. The indication 866 may be obtained in DCI 870, and the timeline may be a function 872 of one or more of: whether the BWP(s) have the configuration restriction 832 based on the RRC parameter reference 830, or a respective quantity of the at least one BWP(s) lacking or having the configuration restriction 832. Thus, the previously described examples related to SCell activation via a switch between dormant and non-dormant BWPs may similarly apply to BWP switching between any active BWPs. For instance, a timeline for BWP switching in general may similarly be dependent on whether an RRC configuration of a target BWP in a cell is restricted or not, on a quantity of simultaneous BWP switches to occur across different carriers of a same cell with RRC restriction, and on a quantity of simultaneous BWP switches to occur across different carriers of a same cell without RRC restriction. For example, a similar X′, Y′, M′, and N′ for BWPs lacking configuration restriction or having configuration restriction may impact a switching timeline between different BWPs of a same cell.

Thus, the aforementioned aspects described with respect to thin RRC configurations and dormant to non-dormant BWP switching, including, for instance, RRC parameter references, RRC profiles, UE capabilities, and configuration restrictions' effect on activation or switching timelines, may be extended to carrier activation and switching in general. For example, these aspects may apply to the case where DCI 870 triggers a switch from one downlink or uplink BWP to another downlink or uplink BWP that is active within one or more cells, or between multiple downlink or uplink BWPs simultaneously in one or more cells. Therefore, the aforementioned aspects that were exemplarily described in connection with single or simultaneous SCell activation including via dormant to non-dormant BWP switching, may be extended to the case of single or simultaneous BWP switching in general within one or more cells.

In one aspect, the indications of restricted versus unrestricted RRC configurations, associated capabilities, and timelines may be defined and reported separately in downlink and uplink. For instance, the aforementioned aspects described with respect to thin RRC configurations, direct and dynamic SCell activation, and general BWP switching, including, for instance, RRC parameter references, RRC profiles, UE capabilities, and configuration restrictions' effect on activation or switching timelines, may be separately associated, configured, defined, or reported for downlink and uplink. This extension of the aforementioned aspects to be independent for downlink and uplink may be relevant to next-generation cases where cell activation or deactivation may be performed separately for downlink and uplink on a given SCell.

In one aspect, this extension may apply in the case when the UE 804 obtains indication 846, 856, or 866 to activate or switch to at least one cell or at least one BWP, the indication being obtained in one of RRC configuration message 848, MAC-CE 860, or DCI 862, 870. In such cases, the at least one cell or the at least one BWP may be associated with separate configurations 874, 876 for downlink communications and uplink communications. These separate configurations 874, 876 may independently include at least one of: the lack of configuration restriction 832 or the configuration restriction 832 based on RRC parameter reference 830 for the at least one cell or the at least one BWP, a plurality of carrier aggregation capabilities such as CA configuration(s) 838 or band combination(s) 840 associated with the at least one cell or the at least one BWP, or the timeline 858, 868 for activating or switching to the at least one cell or the at least one BWP. Moreover, the separate configurations 874, 876 may be independently based on at least one of: whether the RRC parameter reference 830 and the configuration 828 for the at least one cell or the at least one BWP include an identical set of RRC parameters, whether the RRC parameter reference 830 and the configuration 828 for the at least one cell or the at least one BWP include a common set of RRC parameters and a different set of RRC parameters, whether the at least one cell lacks or has the configuration restriction 832 based on the RRC parameter reference 830, whether the at least one BWP lacks or has the configuration restriction 832 based on the RRC parameter reference 830, whether the at least one cell and the at least one BWP both lack the configuration restriction 832, or whether the at least one cell and the at least one BWP both have the configuration restriction 832.

More particularly, in one example, on a given SCell, cell-specific downlink RRC configurations or downlink BWPs may be restricted or borrowed from an RRC parameter reference, while cell-specific uplink RRC configurations or uplink BWPs may not be restricted or serve as RRC parameter references. In another example, timelines for activation of SCells or switching BWPs may be separately defined for uplink or downlink scenarios. For instance, the aforementioned X, Y, M, and N for direct SCell activation timelines, or the aforementioned X′, Y′, M′, and N′ for dynamic SCell activation via dormant to non-dormant BWP switching or for general BWP switching, may be extended such that downlink cells or BWPs have one set of values for any of X, X′, Y, Y′, M, M′, N, and N′, while uplink BWPs have another set of values for any of X, X′, Y, Y′, M, M′, N, and N′. Thus, if downlink cells or BWPs have configuration restriction but uplink cells or BWPs do not have configuration restriction, the activation or switching timeline for downlink may be faster than for uplink. In a further example, a UE may report different carrier aggregation capabilities as a function of whether downlink configurations are restricted, uplink configurations are restricted, both downlink and uplink configurations are restricted, or neither downlink nor uplink configurations are restricted.

In another example, for a given SCell, UE capabilities or timelines may be separately reported or defined for a case of whether all RRC configurations are identical to other reference(s), and for a case of whether there is a common portion of RRC configurations identical to other reference(s) and a delta portion for each RRC configuration which is not borrowed from a reference and is thus different across the configurations. Thus, one set of CA capabilities, set of values for any of X, X′, Y, Y′, M, M′, N, and N′, or the like may be reported or defined for RRC configurations not having any delta portion or which parameters are completely borrowed from those of another reference, and another set of CA capabilities, set of values for any of X, X′, Y, Y′, M, M′, N, and N′, or the like may be reported or defined for RRC configurations having respective delta portions or which parameters are partially but not completely borrowed from those of another reference. In another example, for a given SCell, UE capabilities or timelines may be separately reported or defined for a case of whether cell-specific RRC configurations are restricted, for a case of whether BWP-specific parameters are restricted, for a case of whether both cell-specific and BWP-specific parameters are restricted, and for a case of whether neither cell-specific nor BWP-specific parameters are restricted. Thus, one set of CA capabilities, set of values for any of X, X′, Y, Y′, M, M′, N, and N′, or the like may be reported or defined for RRC configurations which cell-specific parameters are borrowed only, another set of CA capabilities, set of values for any of X, X′, Y, Y′, M, M′, N, and N′, or the like may be reported or defined for RRC configurations which BWP-specific parameters are borrowed only, another set of CA capabilities, set of values for any of X, X′, Y, Y′, M, M′, N, and N′, or the like may be reported or defined for RRC configurations which cell-specific and BWP-specific parameters are both borrowed, and another set of CA capabilities, set of values for any of X, X′, Y, Y′, M, M′, N, and N′, or the like may be reported or defined for RRC configurations which cell-specific and BWP-specific parameters are not borrowed.

In a further example, the two aforementioned examples may be combined with the aspects of downlink and uplink separation as previously described. For instance, one set of CA capabilities, set of values for any of X, X′, Y, Y′, M, M′, N, and N′, or the like may be reported or defined for downlink RRC configurations not having any delta portion, another set of CA capabilities, set of values for any of X, X′, Y, Y′, M, M′, N, and N′, or the like may be reported or defined for downlink RRC configurations having respective delta portions, another set of CA capabilities, set of values for any of X, X′, Y, Y′, M, M′, N, and N′, or the like may be reported or defined for uplink RRC configurations not having any delta portion, and another set of CA capabilities, set of values for any of X, X′, Y, Y′, M, M′, N, and N′, or the like may be reported or defined for uplink RRC configurations having respective delta portions. Similarly, one set of CA capabilities, set of values for any of X, X′, Y, Y′, M, M′, N, and N′, or the like may be reported or defined for downlink RRC configurations which cell-specific parameters are borrowed only, another set of CA capabilities, set of values for any of X, X′, Y, Y′, M, M′, N, and N′, or the like may be reported or defined for uplink RRC configurations which BWP-specific parameters are borrowed only, and the like.

Thus, in the case where a cell is activated for a specific direction or type of communication, such as for downlink or uplink only rather than for both, the aforementioned aspects described with respect to downlink or uplink in general may be applied differently depending on the associated direction or type of the cell. Moreover, the presented capabilities and timelines previously described in connection with other aspects may be defined separately and independently for one or more various cases. That is, the extension of the previously described aspects to the cases of general BWP switching, and to uplink or downlink scenarios, may be alternatively or additionally extended to other cases.

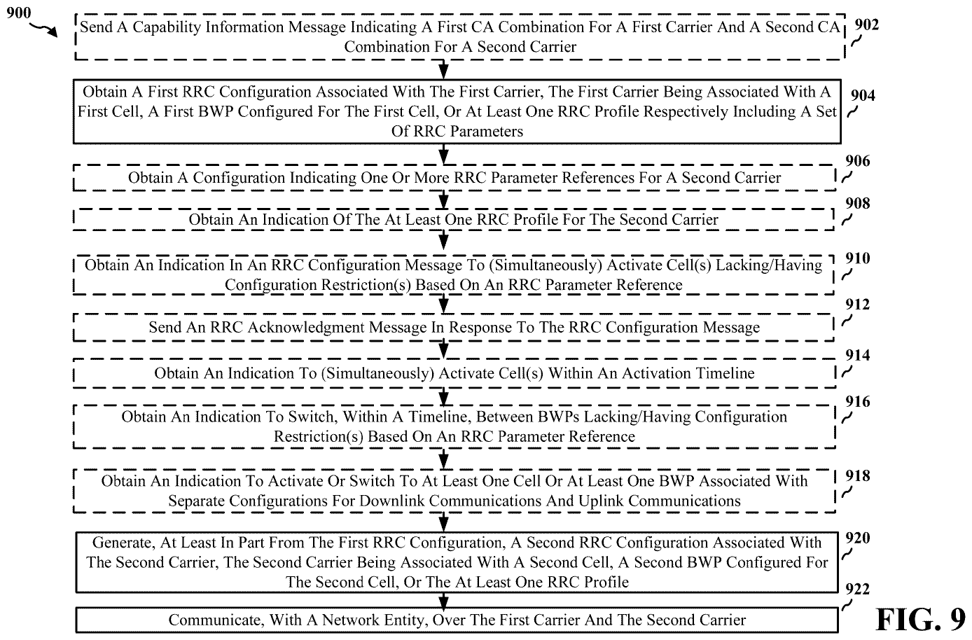

FIG. 9 is a flowchart 900 of a method of wireless communication. The method may be performed by a UE or one or more of its components, for example, the UE 104, 804; UE 350; one or more of RX processor(s) 356, TX processor(s) 368, or controller(s)/processor(s) 359; the apparatus 1102; or cellular baseband processor(s) 1104 or its components. Optional aspects are illustrated in dashed lines.

At block 902, the UE may send a capability information message indicating a first CA combination for a first carrier and a second CA combination for a second carrier, the first CA combination including a first band combination lacking a configuration restriction based on an RRC parameter reference, and the second CA combination including a second band combination having the configuration restriction based on the RRC parameter reference. For example, block 902 may be performed by capability component 1140. For instance, referring to FIG. 8, the UE 804 may transmit capability information message 842 to network entity 802 indicating CA configurations 838 for carriers 808, 814, which CA configurations 838 may respectively include band combinations 840 lacking or having configuration restrictions 832 based on RRC parameter references 830.

In one example, the capability information message may further indicate a third CA combination, the third CA combination including the second band combination having a different configuration restriction based on an RRC parameter reference. For instance, the CA configurations 838 the UE 804 supports with configuration restriction 832 may be reported multiple times with different restrictions.

In one example, the capability information message may further indicate a quantity of RRC parameter references associated with a band combination, a band in the band combination, or the band. In another example, the capability information message may further indicate a same quantity of RRC parameter references, or different quantities of the RRC parameter references, respectively associated with one or more of: the at least one RRC profile, a semi-static configuration for the second cell that includes an RRC parameter reference, or a dynamic configuration activating the second cell that includes the RRC parameter reference.

At block 904, the UE obtains a first RRC configuration associated with a first carrier, the first carrier being associated with a first cell, a first BWP configured for the first cell, or at least one RRC profile respectively including a set of RRC parameters. For example, block 904 may be performed by configuration component 1142. Obtaining the configuration may include, for example, receiving, demodulating, and decoding an encoded and modulated signal including the configuration using one or more of RX processor(s) 356 or controller(s)/processor(s) 359 such as described with respect to UE 350 in FIG. 3.

At block 906, the UE may obtain a configuration indicating or including one or more RRC parameter references for a second carrier. For example, block 906 may be performed by configuration component 1142.

At block 908, the UE may obtain an indication of the at least one RRC profile for the second carrier. For example, block 908 may be performed by configuration component 1142.

At block 910, the UE may obtain an indication in an RRC configuration message to activate a third cell lacking a configuration restriction based on an RRC parameter reference. Alternatively or additionally, the UE may obtain an indication in an RRC configuration message to simultaneously activate a plurality of cells respectively lacking a configuration restriction based on an RRC parameter reference. Alternatively or additionally, the UE may obtain an indication in an RRC configuration message to simultaneously activate at least one third cell lacking a configuration restriction based on an RRC parameter reference and at least one fourth cell having the configuration restriction based on the RRC parameter reference. Alternatively or additionally, the UE may obtain an indication in an RRC configuration message to activate a third cell having a configuration restriction based on an RRC parameter reference. Alternatively or additionally, the UE may obtain an indication in an RRC configuration message to simultaneously activate a plurality of cells respectively having a configuration restriction based on an RRC parameter reference. Alternatively or additionally, the UE may obtain an indication in an RRC configuration message to activate one or more of: at least one third cell lacking a configuration restriction based on an RRC parameter reference, or at least one fourth cell having the configuration restriction based on the RRC parameter reference. For example, block 910 may be performed by configuration component 1142.

At block 912, the UE may send an RRC acknowledgment message in response to the RRC configuration message. For example, block 912 may be performed by data component 1144.

In one example, an RRC procedure delay (TRRC_Process) associated with the obtaining of the RRC configuration message and the sending of the RRC acknowledgment message may be a time (X), the RRC procedure delay for cells having the configuration restriction being zero.

In one example, an RRC procedure delay (TRRC_Process) associated with the obtaining of the RRC configuration message and the sending of the RRC acknowledgment message may be a function of a time (X) and a quantity of the cells (N) indicated as simultaneously activated in the RRC configuration message, the RRC procedure delay for cells having the configuration restriction being zero.

In one example, an RRC procedure delay (TRRC_Process) associated with the obtaining of the RRC configuration message and the sending of the RRC acknowledgment message may be a function of a time (X) and a difference between a quantity of the at least one third cell (N) lacking the configuration restriction and a quantity of the at least one fourth cell (K) having the configuration restriction, the RRC procedure delay for the at least one fourth cell being zero.

In one example, an RRC procedure delay (TRRC_Process) associated with the obtaining of the RRC configuration message and the sending of the RRC acknowledgment message may be a time (X) for cells lacking the configuration restriction, the RRC procedure delay for cells having the configuration restriction being nonzero.

In one example, an RRC procedure delay (TRRC_Process) associated with the obtaining of the RRC configuration message and the sending of the RRC acknowledgment message may be a nonzero time (Y) for cells having the configuration restriction.

In one example, an RRC procedure delay (TRRC_Process) associated with the obtaining of the RRC configuration message and the sending of the RRC acknowledgement message may be a function of a time (X) for cells lacking the configuration restriction and a quantity of the cells (N) indicated as simultaneously activated in the RRC configuration message, the RRC procedure delay for cells having the configuration restriction being nonzero.

In on example, an RRC procedure delay (TRRC_Process) associated with the obtaining of the RRC configuration message and the sending of the RRC acknowledgement message may be a function of a nonzero time (Y) for cells having the configuration restriction and a quantity of the cells (M) indicated as simultaneously activated in the RRC configuration message.

In one example, an RRC procedure delay (TRRC_Process) associated with the obtaining of the RRC configuration message and the sending of the RRC acknowledgement message may be a function of a time (X) for cells lacking the configuration restriction, a quantity of the at least one third cell (N) lacking the configuration restriction, a nonzero time (Y) for cells having the configuration restriction, and a quantity of the at least one fourth cell (M) having the configuration restriction.

In one example, an RRC procedure delay (TRRC_Process) associated with the obtaining of the RRC configuration message and the sending of the RRC acknowledgement message may be a function of at least one of: a time (X) for cells lacking the configuration restriction, or a nonzero time (Y) for cells having the configuration restriction; where at least one of the time (X) or the nonzero time (Y) is fixed or indicated as a UE capability, the UE capability being per UE, per band, per bandwidth class (BC), per band in band combination (BoBC), per downlink feature set (FS), or per uplink FS.

At block 914, the UE may obtain an indication to activate a third cell within an activation timeline. Alternatively or additionally, the UE may obtain an indication to simultaneously activate, within an activation timeline, at least one third cell lacking a configuration restriction based on an RRC parameter reference and at least one fourth cell having the configuration restriction based on the RRC parameter reference. Alternatively or additionally, the UE may obtain an indication to activate, within an activation timeline, one or more of: at least one third cell lacking a configuration restriction based on an RRC parameter reference, or at least one fourth cell having the configuration restriction based on the RRC parameter reference. The indication may be obtained in one of: a MAC-CE, or DCI triggering a switch from a dormant state BWP to a non-dormant state BWP. For example, block 914 may be performed by configuration component 1142.

In one example, the activation timeline may be a function of whether the third cell has a configuration restriction based on an RRC parameter reference. In one example, the activation timeline may be a function of a quantity of the at least one third cell lacking the configuration restriction and a quantity of the at least one fourth cell having the configuration restriction. In one example, the activation timeline may be a function of one or more of: whether the at least one third cell or the at least one fourth cell has the configuration restriction based on the RRC parameter reference, a quantity of the at least one third cell lacking the configuration restriction, or a quantity of the at least one fourth cell having the configuration restriction.

In one example, the activation timeline may further include at least one of: a time (X) for cells lacking the configuration restriction, or a nonzero time (Y) for cells having the configuration restriction; where at least one of the time (X) or the nonzero time (Y) is fixed or indicated as a UE capability, the UE capability being per UE, per band, per bandwidth class (BC), per band in band combination (BoBC), per downlink feature set (FS), or per uplink FS.

At block 916, the UE may obtain an indication to switch, within a timeline, between at least one third BWP lacking a configuration restriction based on an RRC parameter reference and at least one fourth BWP having the configuration restriction based on the RRC parameter reference, the indication being obtained in DCI; and where the timeline is a function of one or more of: whether the at least one third BWP or the at least one fourth BWP has the configuration restriction based on the RRC parameter reference, a quantity of the at least one third BWP lacking the configuration restriction, or a quantity of the at least one fourth BWP having the configuration restriction. For example, block 916 may be performed by configuration component 1142.

At block 918, the UE may obtain an indication to activate or switch to at least one third cell or at least one third BWP, the indication being obtained in one of an RRC configuration message, a MAC-CE, or DCI, where the at least one third cell or the at least one third BWP are associated with separate configurations for downlink communications and uplink communications. The separate configurations may independently include at least one of: a lack of configuration restriction based on an RRC parameter reference for the at least one third cell or the at least one third BWP, the configuration restriction based on the RRC parameter reference for the at least one third cell or the at least one third BWP, a plurality of carrier aggregation capabilities associated with the at least one third cell or the at least one third BWP, or a timeline for activating or switching to the at least one third cell or the at least one third BWP. The separate configurations may also be independently based on at least one of: whether the RRC parameter reference and an RRC configuration for the at least one third cell or the at least one third BWP include an identical set of RRC parameters, whether the RRC parameter reference and the RRC configuration for the at least one third cell or the at least one third BWP include a common set of RRC parameters and a different set of RRC parameters, whether the at least one third cell lacks or has the configuration restriction based on the RRC parameter reference, whether the at least one third BWP lacks or has the configuration restriction based on the RRC parameter reference, whether the at least one third cell and the at least one third BWP both lack the configuration restriction, or whether the at least one third cell and the at least one third BWP both have the configuration restriction. For example, block 918 may be performed by configuration component 1142.

At block 920, the UE generates, at least in part from the first RRC configuration, a second RRC configuration associated with the second carrier, the second carrier being associated with a second cell, a second BWP configured for the second cell, or the at least one RRC profile. For example, block 920 may be performed by configuration component 1142. Generating the configuration may include, for example, obtaining RRC parameters associated with the first RRC configuration, and using one or more of those RRC parameters to create the second RRC configuration.

In one example, the second RRC configuration is at least partially generated from at least a portion of RRC parameters associated with the one or more RRC parameter references at block 906.

In one example, the one or more RRC parameter references includes a first RRC parameter reference associated with common serving cell parameters for the first cell and a second RRC parameter reference associated with BWP-specific parameters for the first BWP, and the second RRC configuration is at least partially generated from the common serving cell parameters or the BWP-specific parameters.

In one example, the one or more RRC parameter references may include a plurality of RRC parameter references associated with different common serving cell parameters for different cells including the first cell, and the second RRC configuration is fully generated from the RRC parameter references.

In one example, the one or more RRC parameter references may include a plurality of RRC parameter references associated with different BWP-specific parameters for different BWPs including the first BWP, and the second RRC configuration is fully generated from the RRC parameter references.

In one example, the RRC parameter reference may indicate one of: the first cell, where the first cell is an activated cell including common serving cell parameters, or the first BWP configured for the first cell, where the first BWP is an activated BWP or a deactivated BWP including BWP-specific parameters; and the second RRC configuration is at least partially generated from at least a portion of the common serving cell parameters or the BWP-specific parameters.

In one example, the second RRC configuration may be at least partially generated for the second BWP from the BWP-specific parameters associated with the first BWP, the second BWP being an initially activated BWP for the second cell.

In one example, the RRC parameter reference may be configured for respective ones of a plurality of carriers including the second carrier.

In one example, different ones of a plurality of RRC parameter references including the RRC parameter reference may be respectively configured for different groups of carriers including the second carrier, and at least one of: a group for the second carrier is indicated in a semi-static configuration or a dynamic configuration; or carriers in the group including the second carrier are associated with a same cell group, a same PUCCH group, a same carrier frequency band, or a same carrier frequency range.

In one example, the configuration including the RRC parameter reference for the second carrier may be one of: a semi-static configuration for the second cell, or a dynamic configuration activating the second cell.

In one example, the second RRC configuration for the second cell or the second BWP may be generated at least partially from the at least one RRC profile in response to the indication at block 908, where the indication of the at least one RRC profile is included in a semi-static configuration for the second cell or a dynamic configuration activating the second cell.

At block 922, the UE communicates, with a network entity, over the first carrier and the second carrier. For example, block 922 may be performed by data component 1144. Communicating may include, for example, receiving, demodulating, and decoding an encoded and modulated signal including data over the carriers using one or more of RX processor(s) 356 or controller(s)/processor(s) 359 such as described with respect to UE 350 in FIG. 3. Alternatively or additionally, communicating may include, for example, encoding, modulating, and transmitting data over the carriers using one or more of TX processor(s) 368 or controller(s)/processor(s) 359 such as described with respect to UE 350 in FIG. 3.

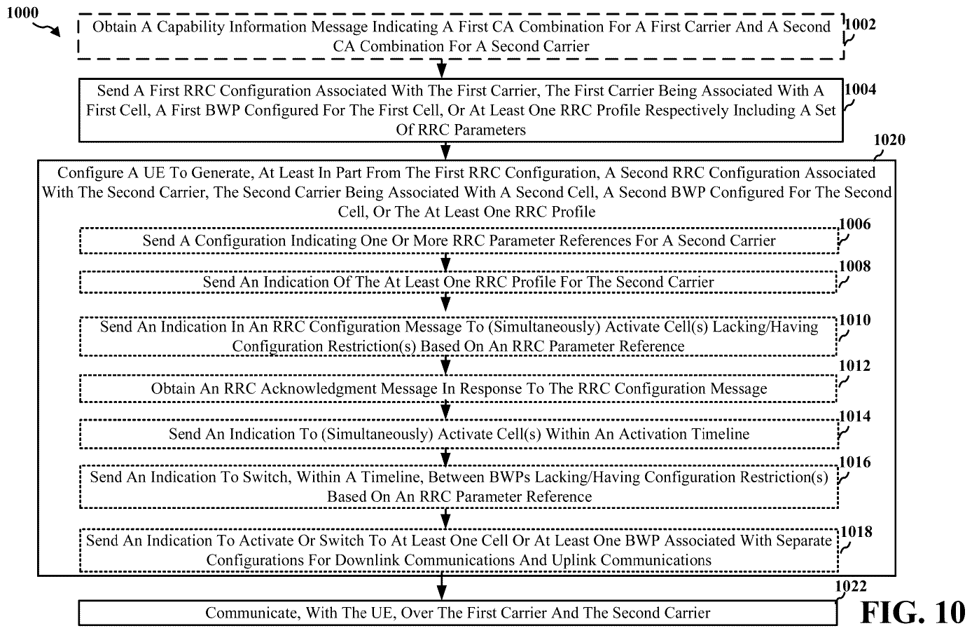

FIG. 10 is a flowchart 1000 of a method of wireless communication. The method may be performed by a network entity or a base station or one or more of its components, for example, the base station 102/180; network entity 802; base station 310; disaggregated base station 181 or one or more of its components; one or more of RX processor(s) 370, TX processor(s) 316, or controller(s)/processor(s) 375; the apparatus 1202; or baseband unit(s) 1204 or its components. Optional aspects are illustrated in dashed lines.

At block 1002, the network entity may obtain a capability information message indicating a first CA combination for a first carrier and a second CA combination for a second carrier, the first CA combination including a first band combination lacking a configuration restriction based on an RRC parameter reference, and the second CA combination including a second band combination having the configuration restriction based on the RRC parameter reference. For example, block 1002 may be performed by capability component 1240.

In one example, the capability information message may further indicate a third CA combination, the third CA combination including the second band combination having a different configuration restriction based on an RRC parameter reference.

In one example, the capability information message may further indicate a quantity of RRC parameter references associated with a band combination, a band in the band combination, or the band. In another example, the capability information message may further indicate a same quantity of RRC parameter references, or different quantities of the RRC parameter references, respectively associated with one or more of: the at least one RRC profile, a semi-static configuration for the second cell that includes an RRC parameter reference, or a dynamic configuration activating the second cell that includes the RRC parameter reference.

At block 1004, the network entity sends a first RRC configuration associated with a first carrier, the first carrier being associated with a first cell, a first BWP configured for the first cell, or at least one RRC profile respectively including a set of RRC parameters. For example, block 1004 may be performed by configuration component 1242. Sending the configuration may include, for example, encoding, modulating, and transmitting the configuration using one or more of TX processor(s) 316 or controller(s)/processor(s) 375 such as described with respect to base station 310 in FIG. 3.

At block 1006, the network entity may send a configuration indicating or including one or more RRC parameter references for a second carrier. For example, block 1006 may be performed by configuration component 1242.

At block 1008, the network entity may send an indication of the at least one RRC profile for the second carrier. For example, block 1008 may be performed by configuration component 1242.

At block 1010, the network entity may send an indication in an RRC configuration message to activate a third cell lacking a configuration restriction based on an RRC parameter reference. Alternatively or additionally, the network entity may send an indication in an RRC configuration message to simultaneously activate a plurality of cells respectively lacking a configuration restriction based on an RRC parameter reference. Alternatively or additionally, the network entity may send an indication in an RRC configuration message to simultaneously activate at least one third cell lacking a configuration restriction based on an RRC parameter reference and at least one fourth cell having the configuration restriction based on the RRC parameter reference. Alternatively or additionally, the network entity may send an indication in an RRC configuration message to activate a third cell having a configuration restriction based on an RRC parameter reference. Alternatively or additionally, the network entity may send an indication in an RRC configuration message to simultaneously activate a plurality of cells respectively having a configuration restriction based on an RRC parameter reference. Alternatively or additionally, the network entity may send an indication in an RRC configuration message to activate one or more of: at least one third cell lacking a configuration restriction based on an RRC parameter reference, or at least one fourth cell having the configuration restriction based on the RRC parameter reference. For example, block 1010 may be performed by configuration component 1242.

At block 1012, the network entity may obtain an RRC acknowledgment message in response to the RRC configuration message. For example, block 1012 may be performed by data component 1244.

In one example, an RRC procedure delay (TRRC_Process) associated with the obtaining of the RRC configuration message and the sending of the RRC acknowledgment message may be a time (X), the RRC procedure delay for cells having the configuration restriction being zero.

In one example, an RRC procedure delay (TRRC_Process) associated with the obtaining of the RRC configuration message and the sending of the RRC acknowledgment message may be a function of a time (X) and a quantity of the cells (N) indicated as simultaneously activated in the RRC configuration message, the RRC procedure delay for cells having the configuration restriction being zero.

In one example, an RRC procedure delay (TRRC_Process) associated with the obtaining of the RRC configuration message and the sending of the RRC acknowledgment message may be a function of a time (X) and a difference between a quantity of the at least one third cell (N) lacking the configuration restriction and a quantity of the at least one fourth cell (K) having the configuration restriction, the RRC procedure delay for the at least one fourth cell being zero.

In one example, an RRC procedure delay (TRRC_Process) associated with the obtaining of the RRC configuration message and the sending of the RRC acknowledgment message may be a time (X) for cells lacking the configuration restriction, the RRC procedure delay for cells having the configuration restriction being nonzero.

In one example, an RRC procedure delay (TRRC_Process) associated with the obtaining of the RRC configuration message and the sending of the RRC acknowledgment message may be a nonzero time (Y) for cells having the configuration restriction.

In one example, an RRC procedure delay (TRRC_Process) associated with the obtaining of the RRC configuration message and the sending of the RRC acknowledgement message may be a function of a time (X) for cells lacking the configuration restriction and a quantity of the cells (N) indicated as simultaneously activated in the RRC configuration message, the RRC procedure delay for cells having the configuration restriction being nonzero.

In on example, an RRC procedure delay (TRRC_Process) associated with the obtaining of the RRC configuration message and the sending of the RRC acknowledgement message may be a function of a nonzero time (Y) for cells having the configuration restriction and a quantity of the cells (M) indicated as simultaneously activated in the RRC configuration message.

In one example, an RRC procedure delay (TRRC_Process) associated with the obtaining of the RRC configuration message and the sending of the RRC acknowledgement message may be a function of a time (X) for cells lacking the configuration restriction, a quantity of the at least one third cell (N) lacking the configuration restriction, a nonzero time (Y) for cells having the configuration restriction, and a quantity of the at least one fourth cell (M) having the configuration restriction.

In one example, an RRC procedure delay (TRRC_Process) associated with the obtaining of the RRC configuration message and the sending of the RRC acknowledgement message may be a function of at least one of: a time (X) for cells lacking the configuration restriction, or a nonzero time (Y) for cells having the configuration restriction; where at least one of the time (X) or the nonzero time (Y) is fixed or indicated as a UE capability, the UE capability being per UE, per band, per bandwidth class (BC), per band in band combination (BoBC), per downlink feature set (FS), or per uplink FS.

At block 1014, the network entity may send an indication to activate a third cell within an activation timeline. Alternatively or additionally, the network entity may send an indication to simultaneously activate, within an activation timeline, at least one third cell lacking a configuration restriction based on an RRC parameter reference and at least one fourth cell having the configuration restriction based on the RRC parameter reference. Alternatively or additionally, the network entity may send an indication to activate, within an activation timeline, one or more of: at least one third cell lacking a configuration restriction based on an RRC parameter reference, or at least one fourth cell having the configuration restriction based on the RRC parameter reference. The indication may be sent in one of: a MAC-CE, or DCI triggering a switch from a dormant state BWP to a non-dormant state BWP. For example, block 1014 may be performed by configuration component 1242.

In one example, the activation timeline may be a function of whether the third cell has a configuration restriction based on an RRC parameter reference. In one example, the activation timeline may be a function of a quantity of the at least one third cell lacking the configuration restriction and a quantity of the at least one fourth cell having the configuration restriction. In one example, the activation timeline may be a function of one or more of: whether the at least one third cell or the at least one fourth cell has the configuration restriction based on the RRC parameter reference, a quantity of the at least one third cell lacking the configuration restriction, or a quantity of the at least one fourth cell having the configuration restriction.

In one example, the activation timeline may further include at least one of: a time (X) for cells lacking the configuration restriction, or a nonzero time (Y) for cells having the configuration restriction; where at least one of the time (X) or the nonzero time (Y) is fixed or indicated as a UE capability, the UE capability being per UE, per band, per bandwidth class (BC), per band in band combination (BoBC), per downlink feature set (FS), or per uplink FS.

At block 1016, the network entity may send an indication to switch, within a timeline, between at least one third BWP lacking a configuration restriction based on an RRC parameter reference and at least one fourth BWP having the configuration restriction based on the RRC parameter reference, the indication being sent in DCI; and where the timeline is a function of one or more of: whether the at least one third BWP or the at least one fourth BWP has the configuration restriction based on the RRC parameter reference, a quantity of the at least one third BWP lacking the configuration restriction, or a quantity of the at least one fourth BWP having the configuration restriction. For example, block 1016 may be performed by configuration component 1242.

At block 1018, the network entity may send an indication to activate or switch to at least one third cell or at least one third BWP, the indication being obtained in one of an RRC configuration message, a MAC-CE, or DCI, where the at least one third cell or the at least one third BWP are associated with separate configurations for downlink communications and uplink communications. The separate configurations may independently include at least one of: a lack of configuration restriction based on an RRC parameter reference for the at least one third cell or the at least one third BWP, the configuration restriction based on the RRC parameter reference for the at least one third cell or the at least one third BWP, a plurality of carrier aggregation capabilities associated with the at least one third cell or the at least one third BWP, or a timeline for activating or switching to the at least one third cell or the at least one third BWP. The separate configurations may also be independently based on at least one of: whether the RRC parameter reference and an RRC configuration for the at least one third cell or the at least one third BWP include an identical set of RRC parameters, whether the RRC parameter reference and the RRC configuration for the at least one third cell or the at least one third BWP include a common set of RRC parameters and a different set of RRC parameters, whether the at least one third cell lacks or has the configuration restriction based on the RRC parameter reference, whether the at least one third BWP lacks or has the configuration restriction based on the RRC parameter reference, whether the at least one third cell and the at least one third BWP both lack the configuration restriction, or whether the at least one third cell and the at least one third BWP both have the configuration restriction. For example, block 1018 may be performed by configuration component 1242.

At block 1020, the network entity configures the UE to generate, at least in part from the first RRC configuration, a second RRC configuration associated with the second carrier, the second carrier being associated with a second cell, a second BWP configured for the second cell, or the at least one RRC profile. For example, block 1020 may be performed by configuration component 1242. Configuring the UE to generate the configuration may include, for example, sending RRC parameters associated with the first RRC configuration, and providing one or more indications, such as described with respect to any of blocks 1006, 1008, 1010, 1012, 1014, 1016, or 1018, triggering the UE to use one or more of those RRC parameters to create the second RRC configuration.

In one example, the second RRC configuration is at least partially generated from at least a portion of RRC parameters associated with the one or more RRC parameter references at block 1006.

In one example, the one or more RRC parameter references includes a first RRC parameter reference associated with common serving cell parameters for the first cell and a second RRC parameter reference associated with BWP-specific parameters for the first BWP, and the second RRC configuration is at least partially generated from the common serving cell parameters or the BWP-specific parameters.

In one example, the one or more RRC parameter references may include a plurality of RRC parameter references associated with different common serving cell parameters for different cells including the first cell, and the second RRC configuration is fully generated from the RRC parameter references.

In one example, the one or more RRC parameter references may include a plurality of RRC parameter references associated with different BWP-specific parameters for different BWPs including the first BWP, and the second RRC configuration is fully generated from the RRC parameter references.

In one example, the RRC parameter reference may indicate one of: the first cell, where the first cell is an activated cell including common serving cell parameters, or the first BWP configured for the first cell, where the first BWP is an activated BWP or a deactivated BWP including BWP-specific parameters; and the second RRC configuration is at least partially generated from at least a portion of the common serving cell parameters or the BWP-specific parameters.

In one example, the second RRC configuration may be at least partially generated for the second BWP from the BWP-specific parameters associated with the first BWP, the second BWP being an initially activated BWP for the second cell.

In one example, the RRC parameter reference may be configured for respective ones of a plurality of carriers including the second carrier.

In one example, different ones of a plurality of RRC parameter references including the RRC parameter reference may be respectively configured for different groups of carriers including the second carrier, and at least one of: a group for the second carrier is indicated in a semi-static configuration or a dynamic configuration; or carriers in the group including the second carrier are associated with a same cell group, a same PUCCH group, a same carrier frequency band, or a same carrier frequency range.

In one example, the configuration including the RRC parameter reference for the second carrier may be one of: a semi-static configuration for the second cell, or a dynamic configuration activating the second cell.

In one example, the second RRC configuration for the second cell or the second BWP may be generated at least partially from the at least one RRC profile in response to the indication at block 1008, where the indication of the at least one RRC profile is included in a semi-static configuration for the second cell or a dynamic configuration activating the second cell.

At block 1022, the network entity communicates, with the UE, over the first carrier and the second carrier. For example, block 1022 may be performed by data component 1244. Communicating may include, for example, receiving, demodulating, and decoding an encoded and modulated signal including data over the carriers using one or more of RX processor(s) 370 or controller(s)/processor(s) 375 such as described with respect to base station 310 in FIG. 3. Alternatively or additionally, communicating may include, for example, encoding, modulating, and transmitting data over the carriers using one or more of TX processor(s) 316 or controller(s)/processor(s) 375 such as described with respect to base station 310 in FIG. 3.

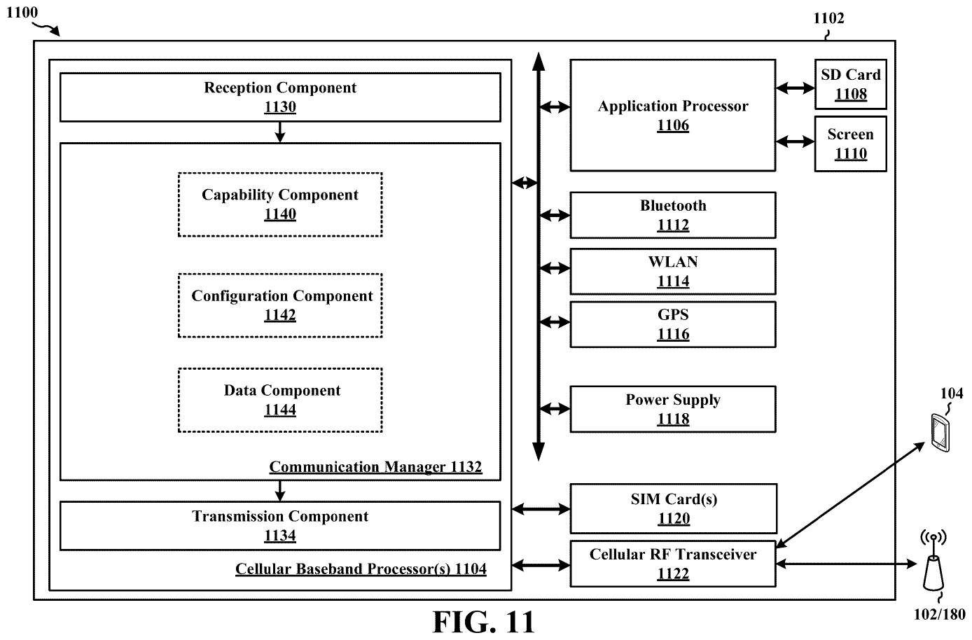

FIG. 11 is a diagram 1100 illustrating an example of a hardware implementation for an apparatus 1102. The apparatus 1102 is a UE and includes one or more cellular baseband processors 1104 (also referred to as a modem) coupled to a cellular RF transceiver 1122 and one or more subscriber identity modules (SIM) cards 1120, an application processor 1106 coupled to a secure digital (SD) card 1108 and a screen 1110, a Bluetooth module 1112, a wireless local area network (WLAN) module 1114, a Global Positioning System (GPS) module 1116, and a power supply 1118. The one or more cellular baseband processors 1104 communicate through the cellular RF transceiver 1122 with the BS 102/180/disaggregated base station 181. For example, the cellular RF transceiver 1122 may correspond to or include the transmitters 354TX, receivers 354RX, and antennas 352 of UE 350.

The one or more cellular baseband processors 1104 may each include a computer-readable medium/one or more memories. The computer-readable medium/one or more memories may be non-transitory. The one or more cellular baseband processors 1104 are responsible for general processing, including the execution of software stored on the computer-readable medium/one or more memories individually or in combination. The software, when executed by the one or more cellular baseband processors 1104, causes the one or more cellular baseband processors 1104 to, individually or in combination, perform the various functions described supra. The computer-readable medium/one or more memories may also be used individually or in combination for storing data that is manipulated by the one or more cellular baseband processors 1104 when executing software. The one or more cellular baseband processors 1104 individually or in combination further include a reception component 1130, a communication manager 1132, and a transmission component 1134. The communication manager 1132 includes the one or more illustrated components. The components within the communication manager 1132 may be stored in the computer-readable medium/one or more memories and/or configured as hardware within the one or more cellular baseband processors 1104. The one or more cellular baseband processors 1104 may be components of the UE 350 and may individually or in combination include the one or more memories 360 and/or at least one of the one or more TX processors 368, at least one of the one or more RX processors 356, and at least one of the one or more controllers/processors 359. For example, the reception component 1130 may include at least the one or more RX processors 356, the transmission component 1134 may include at least the one or more TX processors 368, and the communication manager 1132 may include at least the one or more controllers/processors 359. In one configuration, the apparatus 1102 may be a modem chip and include just the one or more baseband processors 1104, and in another configuration, the apparatus 1102 may be the entire communications device (e.g., see UE 350 of FIG. 3) and include the aforediscussed additional modules of the apparatus 1102.

The communication manager 1132 includes a capability component 1140 that is configured to send a capability information message indicating a first CA combination for a first carrier and a second CA combination for a second carrier, such as described in connection with block 902. The communication manager 1132 further includes a configuration component 1142 that is configured to obtain a first RRC configuration associated with the first carrier, the first carrier being associated with a first cell, a first BWP configured for the first cell, or at least one RRC profile respectively including a set of RRC parameters, such as described in connection with block 904, and to generate, at least in part from the first RRC configuration, a second RRC configuration associated with the second carrier, the second carrier being associated with a second cell, a second BWP configured for the second cell, or the at least one RRC profile, such as described in connection with block 920. In one or more configurations, the configuration component 1142 may additionally be configured to perform any of the following: obtain a configuration indicating one or more RRC parameter references for a second carrier, such as described in connection with block 906; obtain an indication of the at least one RRC profile for the second carrier, such as described in connection with block 908; obtain an indication in an RRC configuration message to (simultaneously) activate cell(s) lacking or having configuration restriction(s) based on an RRC parameter reference, such as described in connection with block 910; send an RRC acknowledgment message in response to the RRC configuration message, such as described in connection with block 912; obtain an indication to (simultaneously) activate cell(s) within an activation timeline, such as described in connection with block 914; obtain an indication to switch, within a timeline, between BWPs lacking/having configuration restriction(s) based on an RRC parameter reference, such as described in connection with block 916; or obtain an indication to activate or switch to at least one cell or at least one BWP associated with separate configurations for downlink communications and uplink communications, such as described in connection with block 918. The communication manager 1132 may further include a data component 1144 that is configured to communicate, with a network entity, over the first carrier and the second carrier, such as described in connection with block 922.

The apparatus may include additional components that perform each of the blocks of the algorithm in the aforementioned flowcharts of FIGS. 8 and 9. As such, each block in the aforementioned flowcharts of FIGS. 8 and 9 may be performed by a component and the apparatus may include one or more of those components. The components may be one or more hardware components specifically configured to carry out the stated processes/algorithm, implemented by one or more processors individually or in combination configured to perform the stated processes/algorithm, stored within a computer-readable medium for implementation by one or more processors, or some combination thereof.

In one configuration, the apparatus 1102, and in particular the one or more cellular baseband processors 1104, includes means for obtaining a first radio resource control (RRC) configuration associated with a first carrier, the first carrier being associated with a first cell, a first bandwidth part (BWP) configured for the first cell, or at least one RRC profile respectively including a set of RRC parameters; means for generating, at least in part from the first RRC configuration, a second RRC configuration associated with a second carrier, the second carrier being associated with a second cell, a second BWP configured for the second cell, or the at least one RRC profile; and means for communicating, with a network entity, over the first carrier and the second carrier.

The aforementioned means may be one or more of the aforementioned components of the apparatus 1102 configured to perform the functions recited by the aforementioned means. As described supra, the apparatus 1102 may include the one or more TX Processors 368, the one or more RX Processors 356, and the one or more controllers/processors 359. As such, in one configuration, the aforementioned means may be at least one of the one or more TX Processors 368, at least one of the one or more RX Processors 356, or at least one of the one or more controllers/processors 359, individually or in any combination configured to perform the functions recited by the aforementioned means.

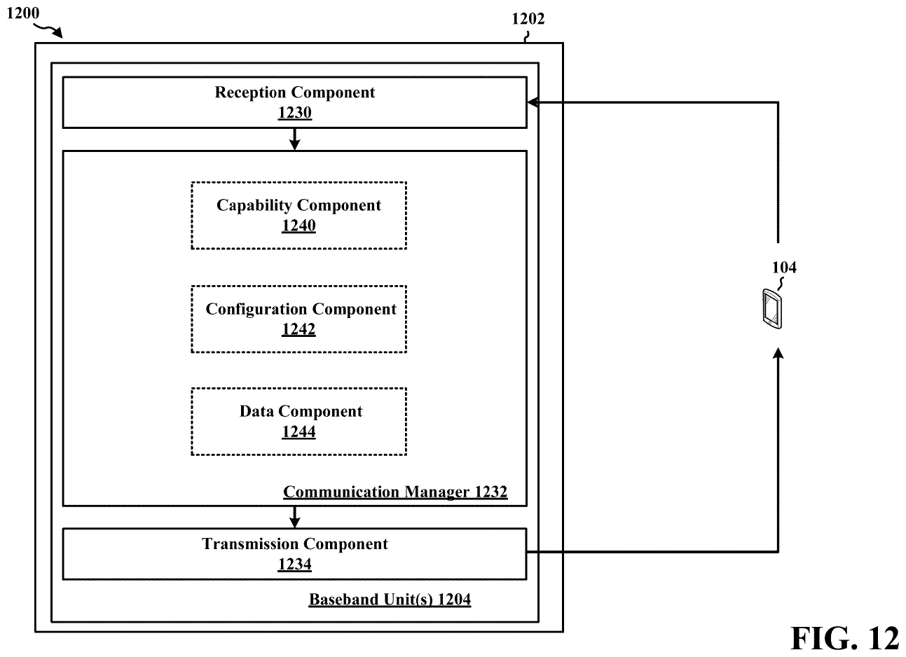

FIG. 12 is a diagram 1200 illustrating an example of a hardware implementation for an apparatus 1202. The apparatus 1202 is a network entity such as a base station, and includes one or more baseband units 1204. The one or more baseband units 1204 communicate through a cellular RF transceiver with the UE 104. For example, the cellular RF transceiver may correspond to or include the transmitters 318TX, receivers 318RX, and antennas 320 of base station 310.

The one or more baseband units 1204 may each include a computer-readable medium/one or more memories. The computer-readable medium/one or more memories may be non-transitory. The one or more baseband units 1204 are responsible for general processing, including the execution of software stored on the computer-readable medium/one or more memories individually or in combination. The software, when executed by the one or more baseband units 1204, causes the one or more baseband units 1204 to, individually or in combination, perform the various functions described supra. The computer-readable medium/one or more memories may also be used individually or in combination for storing data that is manipulated by the one or more baseband units 1204 when executing software. The one or more baseband units 1204 individually or in combination further include a reception component 1230, a communication manager 1232, and a transmission component 1234. The communication manager 1232 includes the one or more illustrated components. The components within the communication manager 1232 may be stored in the computer-readable medium/one or more memories and/or configured as hardware within the one or more baseband units 1204. The one or more baseband units 1204 may be components of the base station 310 and may individually or in combination include the one or more memories 376 and/or at least one of the one or more TX processors 316, at least one of the one or more RX processors 370, and at least one of the one or more controllers/processors 375. For example, the reception component 1230 may include at least the one or more RX processors 370, the transmission component 1234 may include at least the one or more TX processors 316, and the communication manager 1232 may include at least the one or more controllers/processors 375.

The communication manager 1232 includes a capability component 1240 that is configured to obtain a capability information message indicating a first CA combination for a first carrier and a second CA combination for a second carrier, such as described in connection with block 1002. The communication manager 1232 further includes a configuration component 1242 that is configured to send a first RRC configuration associated with the first carrier, the first carrier being associated with a first cell, a first BWP configured for the first cell, or at least one RRC profile respectively including a set of RRC parameters, such as described in connection with block 1004, and to configure the UE to generate, at least in part from the first RRC configuration, a second RRC configuration associated with the second carrier, the second carrier being associated with a second cell, a second BWP configured for the second cell, or the at least one RRC profile, such as described in connection with block 1020. In one or more configurations, the configuration component 1242 may additionally be configured to perform any of the following: send a configuration indicating one or more RRC parameter references for a second carrier, such as described in connection with block 1006; send an indication of the at least one RRC profile for the second carrier, such as described in connection with block 1008; send an indication in an RRC configuration message to (simultaneously) activate cell(s) lacking or having configuration restriction(s) based on an RRC parameter reference, such as described in connection with block 1010; obtain an RRC acknowledgment message in response to the RRC configuration message, such as described in connection with block 1012; send an indication to (simultaneously) activate cell(s) within an activation timeline, such as described in connection with block 1014; send an indication to switch, within a timeline, between BWPs lacking or having configuration restriction(s) based on an RRC parameter reference, such as described in connection with block 1016; or send an indication to activate or switch to at least one cell or at least one BWP associated with separate configurations for downlink communications and uplink communications, such as described in connection with block 1018. The communication manager 1232 may further include a data component 1244 that is configured to communicate, with the UE, over the first carrier and the second carrier, such as described in connection with block 1022.

The apparatus may include additional components that perform each of the blocks of the algorithm in the aforementioned flowchart of FIGS. 8 and 10. As such, each block in the aforementioned flowchart of FIGS. 8 and 10 may be performed by a component and the apparatus may include one or more of those components. The components may be one or more hardware components specifically configured to carry out the stated processes/algorithm, implemented by one or more processors individually or in combination configured to perform the stated processes/algorithm, stored within a computer-readable medium for implementation by one or more processors, or some combination thereof.

In one configuration, the apparatus 1202, and in particular the one or more baseband unit(s) 1204, includes means for sending a first radio resource control (RRC) configuration associated with a first carrier, the first carrier being associated with a first cell, a first bandwidth part (BWP) configured for the first cell, or at least one RRC profile respectively including a set of RRC parameters; means for configuring a user equipment (UE) to generate, at least in part from the first RRC configuration, a second RRC configuration associated with a second carrier, the second carrier being associated with a second cell, a second BWP configured for the second cell, or the at least one RRC profile; and means for communicating, with the UE, over the first carrier and the second carrier.

The aforementioned means may be one or more of the aforementioned components of the apparatus 1202 configured to perform the functions recited by the aforementioned means. As described supra, the apparatus 1202 may include the one or more TX Processors 316, the one or more RX Processors 370, and the one or more controllers/processors 375. As such, in one configuration, the aforementioned means may be at least one of the one or more TX Processors 316, at least one of the one or more RX Processors 370, or at least one of the one or more controllers/processors 375, individually or in any combination configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, a processor, at least one processor, and/or one or more processors, individually or in combination, configured to perform or operable for performing a plurality of actions (such as the functions described supra) is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

Similarly as used herein, a memory, at least one memory, a computer-readable medium, and/or one or more memories, individually or in combination, configured to store or having stored thereon instructions executable by one or more processors for performing a plurality of actions (such as the functions described supra) is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, a computer-readable medium, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, a second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processors may in combination execute the respective subset of instruction to accomplish performing actions X, Y, and Z. Alternatively, a single processor may execute the instructions stored on a single memory, or distributed across multiple memories, to accomplish performing actions X, Y, and Z.

The following examples are illustrative only and may be combined with aspects of other embodiments or teachings described herein, without limitation.
Clause 1. An apparatus for wireless communication, comprising: one or more memories; and one or more processors each communicatively coupled with at least one of the one or more memories, the one or more processors, individually or in any combination, operable to cause the apparatus to: obtain a first radio resource control (RRC) configuration associated with a first carrier, the first carrier being associated with a first cell, a first bandwidth part (BWP) configured for the first cell, or at least one RRC profile respectively including a set of RRC parameters; generate, at least in part from the first RRC configuration, a second RRC configuration associated with a second carrier, the second carrier being associated with a second cell, a second BWP configured for the second cell, or the at least one RRC profile; and communicate, with a network entity, over the first carrier and the second carrier.
Clause 2. The apparatus of clause 1, wherein the one or more processors, individually or in any combination, are further operable to cause the apparatus to: obtain a configuration indicating one or more RRC parameter references for the second carrier, wherein the second RRC configuration is at least partially generated from at least a portion of RRC parameters associated with the one or more RRC parameter references; wherein the one or more RRC parameter references include a first RRC parameter reference associated with common serving cell parameters for the first cell and a second RRC parameter reference associated with BWP-specific parameters for the first BWP, and the second RRC configuration is at least partially generated from the common serving cell parameters or the BWP-specific parameters.
Clause 3. The apparatus of clause 2, wherein the one or more RRC parameter references include a plurality of RRC parameter references associated with different common serving cell parameters for different cells including the first cell, and the second RRC configuration is fully generated from the RRC parameter references.
Clause 4. The apparatus of clause 2 or clause 3, wherein the one or more RRC parameter references include a plurality of RRC parameter references associated with different BWP-specific parameters for different BWPs including the first BWP, and the second RRC configuration is fully generated from the RRC parameter references.
Clause 5. The apparatus of any of clauses 1 to 4, wherein the one or more processors, individually or in any combination, are further operable to cause the apparatus to: obtain a configuration including an RRC parameter reference for the second carrier, the RRC parameter reference indicating one of: the first cell, wherein the first cell is an activated cell including common serving cell parameters, or the first BWP configured for the first cell, wherein the first BWP is an activated BWP or a deactivated BWP including BWP-specific parameters; and wherein the second RRC configuration is at least partially generated from at least a portion of the common serving cell parameters or the BWP-specific parameters.
Clause 6. The apparatus of clause 5, wherein the second RRC configuration is at least partially generated for the second BWP from the BWP-specific parameters associated with the first BWP, the second BWP being an initially activated BWP for the second cell.
Clause 7. The apparatus of clause 5 or clause 6, wherein the RRC parameter reference is configured for respective ones of a plurality of carriers including the second carrier.
Clause 8. The apparatus of any of clauses 5 to 7, wherein different ones of a plurality of RRC parameter references including the RRC parameter reference are respectively configured for different groups of carriers including the second carrier; and at least one of: wherein a group for the second carrier is indicated in a semi-static configuration or a dynamic configuration; or wherein carriers in the group including the second carrier are associated with a same cell group, a same physical uplink control channel (PUCCH) group, a same carrier frequency band, or a same carrier frequency range.
Clause 9. The apparatus of any of clauses 5 to 8, wherein the configuration including the RRC parameter reference for the second carrier is one of: a semi-static configuration for the second cell, or a dynamic configuration activating the second cell.
Clause 10. The apparatus of any of clauses 1 to 9, wherein the one or more processors, individually or in any combination, are further operable to cause the apparatus to: obtain an indication of the at least one RRC profile for the second carrier, the second RRC configuration for the second cell or the second BWP being generated at least partially from the at least one RRC profile in response to the indication; wherein the indication of the at least one RRC profile is included in a semi-static configuration for the second cell or a dynamic configuration activating the second cell.
Clause 11. The apparatus of any of clauses 1 to 10, wherein the one or more processors, individually or in any combination, are further operable to cause the apparatus to: send a capability information message indicating a first carrier aggregation (CA) combination for the first carrier and a second CA combination for the second carrier, the first CA combination including a first band combination lacking a configuration restriction based on an RRC parameter reference, and the second CA combination including a second band combination having the configuration restriction based on the RRC parameter reference.
Clause 12. The apparatus of clause 11, wherein the capability information message further indicates a third CA combination, the third CA combination including the second band combination having a different configuration restriction based on an RRC parameter reference.
Clause 13. The apparatus of clause 11 or clause 12, wherein at least one of: the capability information message further indicates a quantity of RRC parameter references associated with a band combination, a band in the band combination, or the band; or the capability information message further indicates a same quantity of RRC parameter references, or different quantities of the RRC parameter references, respectively associated with one or more of: the at least one RRC profile, a semi-static configuration for the second cell that includes an RRC parameter reference, or a dynamic configuration activating the second cell that includes the RRC parameter reference.
Clause 14. The apparatus of any of clauses 1 to 13, wherein the one or more processors, individually or in any combination, are further operable to cause the apparatus to: obtain an indication in an RRC configuration message to activate a third cell lacking a configuration restriction based on an RRC parameter reference; send an RRC acknowledgment message in response to the RRC configuration message; and wherein an RRC procedure delay (TRRC_Process) associated with the obtaining of the RRC configuration message and the sending of the RRC acknowledgment message is a time (X), the RRC procedure delay for cells having the configuration restriction being zero.
Clause 15. The apparatus of any of clauses 1 to 14, wherein the one or more processors, individually or in any combination, are further operable to cause the apparatus to: obtain an indication in an RRC configuration message to simultaneously activate a plurality of cells respectively lacking a configuration restriction based on an RRC parameter reference; send an RRC acknowledgment message in response to the RRC configuration message; and wherein an RRC procedure delay (TRRC_Process) associated with the obtaining of the RRC configuration message and the sending of the RRC acknowledgment message is a function of a time (X) and a quantity of the cells (N) indicated as simultaneously activated in the RRC configuration message, the RRC procedure delay for cells having the configuration restriction being zero.
Clause 16. The apparatus of any of clauses 1 to 15, wherein the one or more processors, individually or in any combination, are further operable to cause the apparatus to: obtain an indication in an RRC configuration message to simultaneously activate at least one third cell lacking a configuration restriction based on an RRC parameter reference and at least one fourth cell having the configuration restriction based on the RRC parameter reference; send an RRC acknowledgment message in response to the RRC configuration message; and wherein an RRC procedure delay (TRRC_Process) associated with the obtaining of the RRC configuration message and the sending of the RRC acknowledgment message is a function of a time (X) and a difference between a quantity of the at least one third cell (N) lacking the configuration restriction and a quantity of the at least one fourth cell (K) having the configuration restriction, the RRC procedure delay for the at least one fourth cell being zero.
Clause 17. The apparatus of any of clauses 1 to 16, wherein the one or more processors, individually or in any combination, are further operable to cause the apparatus to: obtain an indication in an RRC configuration message to activate a third cell lacking a configuration restriction based on an RRC parameter reference; send an RRC acknowledgment message in response to the RRC configuration message; and wherein an RRC procedure delay (TRRC_Process) associated with the obtaining of the RRC configuration message and the sending of the RRC acknowledgment message is a time (X) for cells lacking the configuration restriction, the RRC procedure delay for cells having the configuration restriction being nonzero.
Clause 18. The apparatus of any of clauses 1 to 17, wherein the one or more processors, individually or in any combination, are further operable to cause the apparatus to: obtain an indication in an RRC configuration message to activate a third cell having a configuration restriction based on an RRC parameter reference; send an RRC acknowledgement message in response to the RRC configuration message; and wherein an RRC procedure delay (TRRC_Process) associated with the obtaining of the RRC configuration message and the sending of the RRC acknowledgment message is a nonzero time (Y) for cells having the configuration restriction.
Clause 19. The apparatus of any of clauses 1 to 18, wherein the one or more processors, individually or in any combination, are further operable to cause the apparatus to: obtain an indication in an RRC configuration message to simultaneously activate a plurality of cells respectively lacking a configuration restriction based on an RRC parameter reference; send an RRC acknowledgment message in response to the RRC configuration message; and wherein an RRC procedure delay (TRRC_Process) associated with the obtaining of the RRC configuration message and the sending of the RRC acknowledgement message is a function of a time (X) for cells lacking the configuration restriction and a quantity of the cells (N) indicated as simultaneously activated in the RRC configuration message, the RRC procedure delay for cells having the configuration restriction being nonzero.
Clause 20. The apparatus of any of clauses 1 to 19, wherein the one or more processors, individually or in any combination, are further operable to cause the apparatus to: obtain an indication in an RRC configuration message to simultaneously activate a plurality of cells respectively having a configuration restriction based on an RRC parameter reference; send an RRC acknowledgment message in response to the RRC configuration message; and wherein an RRC procedure delay (TRRC_Process) associated with the obtaining of the RRC configuration message and the sending of the RRC acknowledgement message is a function of a nonzero time (Y) for cells having the configuration restriction and a quantity of the cells (M) indicated as simultaneously activated in the RRC configuration message.
Clause 21. The apparatus of any of clauses 1 to 20, wherein the one or more processors, individually or in any combination, are further operable to cause the apparatus to: obtain an indication in an RRC configuration message to simultaneously activate at least one third cell lacking a configuration restriction based on an RRC parameter reference and at least one fourth cell having the configuration restriction based on the RRC parameter reference; send an RRC acknowledgement message in response to the RRC configuration message; and wherein an RRC procedure delay (TRRC_Process) associated with the obtaining of the RRC configuration message and the sending of the RRC acknowledgement message is a function of a time (X) for cells lacking the configuration restriction, a quantity of the at least one third cell (N) lacking the configuration restriction, a nonzero time (Y) for cells having the configuration restriction, and a quantity of the at least one fourth cell (M) having the configuration restriction.
Clause 22. The apparatus of any of clauses 1 to 21, wherein the one or more processors, individually or in any combination, are further operable to cause the apparatus to: obtain an indication to activate a third cell within an activation timeline, the indication being obtained in one of: a medium access control (MAC) control element (MAC-CE), or downlink control information (DCI) triggering a switch from a dormant state BWP to a non-dormant state BWP; wherein the activation timeline is a function of whether the third cell has a configuration restriction based on an RRC parameter reference.
Clause 23. The apparatus of any of clauses 1 to 22, wherein the one or more processors, individually or in any combination, are further operable to cause the apparatus to: obtain an indication to simultaneously activate, within an activation timeline, at least one third cell lacking a configuration restriction based on an RRC parameter reference and at least one fourth cell having the configuration restriction based on the RRC parameter reference, the indication being obtained in one of: a medium access control (MAC) control element (MAC-CE), or downlink control information (DCI) triggering a switch from a dormant state BWP to a non-dormant state BWP; wherein the activation timeline is a function of a quantity of the at least one third cell lacking the configuration restriction and a quantity of the at least one fourth cell having the configuration restriction.
Clause 24. The apparatus of any of clauses 1 to 23, wherein the one or more processors, individually or in any combination, are further operable to cause the apparatus to: obtain an indication in an RRC configuration message to activate one or more of: at least one third cell lacking a configuration restriction based on an RRC parameter reference, or at least one fourth cell having the configuration restriction based on the RRC parameter reference; send an RRC acknowledgement message in response to the RRC configuration message; and wherein an RRC procedure delay (TRRC_Process) associated with the obtaining of the RRC configuration message and the sending of the RRC acknowledgement message is a function of at least one of: a time (X) for cells lacking the configuration restriction, or a nonzero time (Y) for cells having the configuration restriction; wherein at least one of the time (X) or the nonzero time (Y) is fixed or indicated as a user equipment (UE) capability, the UE capability being per UE, per band, per bandwidth class (BC), per band in band combination (BoBC), per downlink feature set (FS), or per uplink FS.
Clause 25. The apparatus of any of clauses 1 to 24, wherein the one or more processors, individually or in any combination, are further operable to cause the apparatus to: obtain an indication to activate, within an activation timeline, one or more of: at least one third cell lacking a configuration restriction based on an RRC parameter reference, or at least one fourth cell having the configuration restriction based on the RRC parameter reference; the indication being obtained in one of: a medium access control (MAC) control element (MAC-CE), or downlink control information (DCI) triggering a switch from a dormant state BWP to a non-dormant state BWP; wherein the activation timeline is a function of one or more of: whether the at least one third cell or the at least one fourth cell has the configuration restriction based on the RRC parameter reference, a quantity of the at least one third cell lacking the configuration restriction, or a quantity of the at least one fourth cell having the configuration restriction; wherein the activation timeline further includes at least one of: a time (X) for cells lacking the configuration restriction, or a nonzero time (Y) for cells having the configuration restriction; and wherein at least one of the time (X) or the nonzero time (Y) is fixed or indicated as a user equipment (UE) capability, the UE capability being per UE, per band, per bandwidth class (BC), per band in band combination (BoBC), per downlink feature set (FS), or per uplink FS.
Clause 26. The apparatus of any of clauses 1 to 25, wherein the one or more processors, individually or in any combination, are further operable to cause the apparatus to: obtain an indication to switch, within a timeline, between at least one third BWP lacking a configuration restriction based on an RRC parameter reference and at least one fourth BWP having the configuration restriction based on the RRC parameter reference, the indication being obtained in downlink control information (DCI); and wherein the timeline is a function of one or more of: whether the at least one third BWP or the at least one fourth BWP has the configuration restriction based on the RRC parameter reference, a quantity of the at least one third BWP lacking the configuration restriction, or a quantity of the at least one fourth BWP having the configuration restriction.
Clause 27. The apparatus of any of clauses 1 to 26, wherein the one or more processors, individually or in any combination, are further operable to cause the apparatus to: obtain an indication to activate or switch to at least one third cell or at least one third BWP, the indication being obtained in one of an RRC configuration message, a medium access control (MAC) control element (MAC-CE), or downlink control information (DCI), wherein the at least one third cell or the at least one third BWP are associated with separate configurations for downlink communications and uplink communications, the separate configurations independently including at least one of: a lack of configuration restriction based on an RRC parameter reference for the at least one third cell or the at least one third BWP, the configuration restriction based on the RRC parameter reference for the at least one third cell or the at least one third BWP, a plurality of carrier aggregation capabilities associated with the at least one third cell or the at least one third BWP, or a timeline for activating or switching to the at least one third cell or the at least one third BWP; and wherein the separate configurations are independently based on at least one of: whether the RRC parameter reference and an RRC configuration for the at least one third cell or the at least one third BWP include an identical set of RRC parameters, whether the RRC parameter reference and the RRC configuration for the at least one third cell or the at least one third BWP include a common set of RRC parameters and a different set of RRC parameters, whether the at least one third cell lacks or has the configuration restriction based on the RRC parameter reference, whether the at least one third BWP lacks or has the configuration restriction based on the RRC parameter reference, whether the at least one third cell and the at least one third BWP both lack the configuration restriction, or whether the at least one third cell and the at least one third BWP both have the configuration restriction.
Clause 28. A method of wireless communication performable at a user equipment (UE), comprising: obtaining a first radio resource control (RRC) configuration associated with a first carrier, the first carrier being associated with a first cell, a first bandwidth part (BWP) configured for the first cell, or at least one RRC profile respectively including a set of RRC parameters; generating, at least in part from the first RRC configuration, a second RRC configuration associated with a second carrier, the second carrier being associated with a second cell, a second BWP configured for the second cell, or the at least one RRC profile; and communicating, with a network entity, over the first carrier and the second carrier.
Clause 29. An apparatus for wireless communication, comprising: one or more memories; and one or more processors each communicatively coupled with at least one of the one or more memories, the one or more processors, individually or in any combination, operable to cause the apparatus to: send a first radio resource control (RRC) configuration associated with a first carrier, the first carrier being associated with a first cell, a first bandwidth part (BWP) configured for the first cell, or at least one RRC profile respectively including a set of RRC parameters; configure a user equipment (UE) to generate, at least in part from the first RRC configuration, a second RRC configuration associated with a second carrier, the second carrier being associated with a second cell, a second BWP configured for the second cell, or the at least one RRC profile; and communicate, with the UE, over the first carrier and the second carrier.
Clause 30. A method of wireless communication performable at a network entity, comprising: sending a first radio resource control (RRC) configuration associated with a first carrier, the first carrier being associated with a first cell, a first bandwidth part (BWP) configured for the first cell, or at least one RRC profile respectively including a set of RRC parameters; configuring a user equipment (UE) to generate, at least in part from the first RRC configuration, a second RRC configuration associated with a second carrier, the second carrier being associated with a second cell, a second BWP configured for the second cell, or the at least one RRC profile; and communicating, with the UE, over the first carrier and the second carrier.

What is claimed is:

1. An apparatus for wireless communication, comprising:
one or more memories; and
one or more processors each communicatively coupled with at least one of the one or more memories, the one or more processors, individually or in any combination, operable to cause the apparatus to:
obtain a first radio resource control (RRC) configuration associated with a first carrier, the first carrier being associated with a first cell, a first bandwidth part (BWP) configured for the first cell, or at least one RRC profile respectively including a set of RRC parameters;
generate, at least in part from the first RRC configuration, a second RRC configuration associated with a second carrier, the second carrier being associated with a second cell, a second BWP configured for the second cell, or the at least one RRC profile; and
communicate, with a network entity, over the first carrier and the second carrier.

2. The apparatus of claim 1, wherein the one or more processors, individually or in any combination, are further operable to cause the apparatus to:
obtain a configuration indicating one or more RRC parameter references for the second carrier, wherein the second RRC configuration is at least partially generated from at least a portion of RRC parameters associated with the one or more RRC parameter references;
wherein the one or more RRC parameter references include a first RRC parameter reference associated with common serving cell parameters for the first cell and a second RRC parameter reference associated with BWP-specific parameters for the first BWP, and the second RRC configuration is at least partially generated from the common serving cell parameters or the BWP-specific parameters.

3. The apparatus of claim 2, wherein the one or more RRC parameter references include a plurality of RRC parameter references associated with different common serving cell parameters for different cells including the first cell, and the second RRC configuration is fully generated from the RRC parameter references.

4. The apparatus of claim 2, wherein the one or more RRC parameter references include a plurality of RRC parameter references associated with different BWP-specific parameters for different BWPs including the first BWP, and the second RRC configuration is fully generated from the RRC parameter references.

5. The apparatus of claim 1, wherein the one or more processors, individually or in any combination, are further operable to cause the apparatus to:
obtain a configuration including an RRC parameter reference for the second carrier, the RRC parameter reference indicating one of:
the first cell, wherein the first cell is an activated cell including common serving cell parameters, or
the first BWP configured for the first cell, wherein the first BWP is an activated BWP or a deactivated BWP including BWP-specific parameters; and
wherein the second RRC configuration is at least partially generated from at least a portion of the common serving cell parameters or the BWP-specific parameters.

6. The apparatus of claim 5, wherein the second RRC configuration is at least partially generated for the second BWP from the BWP-specific parameters associated with the first BWP, the second BWP being an initially activated BWP for the second cell.

7. The apparatus of claim 5, wherein the RRC parameter reference is configured for respective ones of a plurality of carriers including the second carrier.

8. The apparatus of claim 5,
wherein different ones of a plurality of RRC parameter references including the RRC parameter reference are respectively configured for different groups of carriers including the second carrier; and
at least one of:
wherein a group for the second carrier is indicated in a semi-static configuration or a dynamic configuration; or
wherein carriers in the group including the second carrier are associated with a same cell group, a same physical uplink control channel (PUCCH) group, a same carrier frequency band, or a same carrier frequency range.

9. The apparatus of claim 5, wherein the configuration including the RRC parameter reference for the second carrier is one of: a semi-static configuration for the second cell, or a dynamic configuration activating the second cell.

10. The apparatus of claim 1, wherein the one or more processors, individually or in any combination, are further operable to cause the apparatus to:
obtain an indication of the at least one RRC profile for the second carrier, the second RRC configuration for the second cell or the second BWP being generated at least partially from the at least one RRC profile in response to the indication;
wherein the indication of the at least one RRC profile is included in a semi-static configuration for the second cell or a dynamic configuration activating the second cell.

11. The apparatus of claim 1, wherein the one or more processors, individually or in any combination, are further operable to cause the apparatus to:
send a capability information message indicating a first carrier aggregation (CA) combination for the first carrier and a second CA combination for the second carrier, the first CA combination including a first band combination lacking a configuration restriction based on an RRC parameter reference, and the second CA combination including a second band combination having the configuration restriction based on the RRC parameter reference.

12. The apparatus of claim 11, wherein the capability information message further indicates a third CA combination, the third CA combination including the second band combination having a different configuration restriction based on an RRC parameter reference.

13. The apparatus of claim 11, wherein at least one of:
the capability information message further indicates a quantity of RRC parameter references associated with a band combination, a band in the band combination, or the band; or
the capability information message further indicates a same quantity of RRC parameter references, or different quantities of the RRC parameter references, respectively associated with one or more of:
the at least one RRC profile,
a semi-static configuration for the second cell that includes an RRC parameter reference, or
a dynamic configuration activating the second cell that includes the RRC parameter reference.

14. The apparatus of claim 1, wherein the one or more processors, individually or in any combination, are further operable to cause the apparatus to:
obtain an indication in an RRC configuration message to activate a third cell lacking a configuration restriction based on an RRC parameter reference;
send an RRC acknowledgment message in response to the RRC configuration message; and
wherein an RRC procedure delay (TRRC_Process) associated with the obtaining of the RRC configuration message and the sending of the RRC acknowledgment message is a time (X), the RRC procedure delay for cells having the configuration restriction being zero.

15. The apparatus of claim 1, wherein the one or more processors, individually or in any combination, are further operable to cause the apparatus to:
obtain an indication in an RRC configuration message to simultaneously activate a plurality of cells respectively lacking a configuration restriction based on an RRC parameter reference;
send an RRC acknowledgment message in response to the RRC configuration message; and
wherein an RRC procedure delay (TRRC_Process) associated with the obtaining of the RRC configuration message and the sending of the RRC acknowledgment message is a function of a time (X) and a quantity of the cells (N) indicated as simultaneously activated in the RRC configuration message, the RRC procedure delay for cells having the configuration restriction being zero.

16. The apparatus of claim 1, wherein the one or more processors, individually or in any combination, are further operable to cause the apparatus to:
obtain an indication in an RRC configuration message to simultaneously activate at least one third cell lacking a configuration restriction based on an RRC parameter reference and at least one fourth cell having the configuration restriction based on the RRC parameter reference;
send an RRC acknowledgment message in response to the RRC configuration message; and
wherein an RRC procedure delay (TRRC_Process) associated with the obtaining of the RRC configuration message and the sending of the RRC acknowledgment message is a function of a time (X) and a difference between a quantity of the at least one third cell (N) lacking the configuration restriction and a quantity of the at least one fourth cell (K) having the configuration restriction, the RRC procedure delay for the at least one fourth cell being zero.

17. The apparatus of claim 1, wherein the one or more processors, individually or in any combination, are further operable to cause the apparatus to:
obtain an indication in an RRC configuration message to activate a third cell lacking a configuration restriction based on an RRC parameter reference;
send an RRC acknowledgment message in response to the RRC configuration message; and
wherein an RRC procedure delay (TRRC_Process) associated with the obtaining of the RRC configuration message and the sending of the RRC acknowledgment message is a time (X) for cells lacking the configuration restriction, the RRC procedure delay for cells having the configuration restriction being nonzero.

18. The apparatus of claim 1, wherein the one or more processors, individually or in any combination, are further operable to cause the apparatus to:
obtain an indication in an RRC configuration message to activate a third cell having a configuration restriction based on an RRC parameter reference;
send an RRC acknowledgement message in response to the RRC configuration message; and
wherein an RRC procedure delay (TRRC_Process) associated with the obtaining of the RRC configuration message and the sending of the RRC acknowledgment message is a nonzero time (Y) for cells having the configuration restriction.

19. The apparatus of claim 1, wherein the one or more processors, individually or in any combination, are further operable to cause the apparatus to:
obtain an indication in an RRC configuration message to simultaneously activate a plurality of cells respectively lacking a configuration restriction based on an RRC parameter reference;
send an RRC acknowledgment message in response to the RRC configuration message; and
wherein an RRC procedure delay (TRRC_Process) associated with the obtaining of the RRC configuration message and the sending of the RRC acknowledgement message is a function of a time (X) for cells lacking the configuration restriction and a quantity of the cells (N) indicated as simultaneously activated in the RRC configuration message, the RRC procedure delay for cells having the configuration restriction being nonzero.

20. The apparatus of claim 1, wherein the one or more processors, individually or in any combination, are further operable to cause the apparatus to:
obtain an indication in an RRC configuration message to simultaneously activate a plurality of cells respectively having a configuration restriction based on an RRC parameter reference;
send an RRC acknowledgment message in response to the RRC configuration message; and
wherein an RRC procedure delay (TRRC_Process) associated with the obtaining of the RRC configuration message and the sending of the RRC acknowledgement message is a function of a nonzero time (Y) for cells having the configuration restriction and a quantity of the cells (M) indicated as simultaneously activated in the RRC configuration message.

21. The apparatus of claim 1, wherein the one or more processors, individually or in any combination, are further operable to cause the apparatus to:
obtain an indication in an RRC configuration message to simultaneously activate at least one third cell lacking a configuration restriction based on an RRC parameter reference and at least one fourth cell having the configuration restriction based on the RRC parameter reference;
send an RRC acknowledgement message in response to the RRC configuration message; and
wherein an RRC procedure delay (TRRC_Process) associated with the obtaining of the RRC configuration message and the sending of the RRC acknowledgement message is a function of a time (X) for cells lacking the configuration restriction, a quantity of the at least one third cell (N) lacking the configuration restriction, a nonzero time (Y) for cells having the configuration restriction, and a quantity of the at least one fourth cell (M) having the configuration restriction.

22. The apparatus of claim 1, wherein the one or more processors, individually or in any combination, are further operable to cause the apparatus to:
obtain an indication to activate a third cell within an activation timeline, the indication being obtained in one of:
a medium access control (MAC) control element (MAC-CE), or
downlink control information (DCI) triggering a switch from a dormant state BWP to a non-dormant state BWP;
wherein the activation timeline is a function of whether the third cell has a configuration restriction based on an RRC parameter reference.

23. The apparatus of claim 1, wherein the one or more processors, individually or in any combination, are further operable to cause the apparatus to:
obtain an indication to simultaneously activate, within an activation timeline, at least one third cell lacking a configuration restriction based on an RRC parameter reference and at least one fourth cell having the configuration restriction based on the RRC parameter reference, the indication being obtained in one of:
a medium access control (MAC) control element (MAC-CE), or
downlink control information (DCI) triggering a switch from a dormant state BWP to a non-dormant state BWP;
wherein the activation timeline is a function of a quantity of the at least one third cell lacking the configuration restriction and a quantity of the at least one fourth cell having the configuration restriction.

24. The apparatus of claim 1, wherein the one or more processors, individually or in any combination, are further operable to cause the apparatus to:
obtain an indication in an RRC configuration message to activate one or more of:
at least one third cell lacking a configuration restriction based on an RRC parameter reference, or
at least one fourth cell having the configuration restriction based on the RRC parameter reference;
send an RRC acknowledgement message in response to the RRC configuration message; and
wherein an RRC procedure delay (TRRC_Process) associated with the obtaining of the RRC configuration message and the sending of the RRC acknowledgement message is a function of at least one of:
a time (X) for cells lacking the configuration restriction, or
a nonzero time (Y) for cells having the configuration restriction;
wherein at least one of the time (X) or the nonzero time (Y) is fixed or indicated as a user equipment (UE) capability, the UE capability being per UE, per band, per bandwidth class (BC), per band in band combination (BoBC), per downlink feature set (FS), or per uplink FS.

25. The apparatus of claim 1, wherein the one or more processors, individually or in any combination, are further operable to cause the apparatus to:
obtain an indication to activate, within an activation timeline, one or more of:
at least one third cell lacking a configuration restriction based on an RRC parameter reference, or
at least one fourth cell having the configuration restriction based on the RRC parameter reference;
the indication being obtained in one of:
a medium access control (MAC) control element (MAC-CE), or
downlink control information (DCI) triggering a switch from a dormant state BWP to a non-dormant state BWP;
wherein the activation timeline is a function of one or more of:
whether the at least one third cell or the at least one fourth cell has the configuration restriction based on the RRC parameter reference,
a quantity of the at least one third cell lacking the configuration restriction, or
a quantity of the at least one fourth cell having the configuration restriction;
wherein the activation timeline further includes at least one of:
a time (X) for cells lacking the configuration restriction, or
a nonzero time (Y) for cells having the configuration restriction; and
wherein at least one of the time (X) or the nonzero time (Y) is fixed or indicated as a user equipment (UE) capability, the UE capability being per UE, per band, per bandwidth class (BC), per band in band combination (BoBC), per downlink feature set (FS), or per uplink FS.

26. The apparatus of claim 1, wherein the one or more processors, individually or in any combination, are further operable to cause the apparatus to:
obtain an indication to switch, within a timeline, between at least one third BWP lacking a configuration restriction based on an RRC parameter reference and at least one fourth BWP having the configuration restriction based on the RRC parameter reference, the indication being obtained in downlink control information (DCI); and
wherein the timeline is a function of one or more of:
whether the at least one third BWP or the at least one fourth BWP has the configuration restriction based on the RRC parameter reference,
a quantity of the at least one third BWP lacking the configuration restriction, or
a quantity of the at least one fourth BWP having the configuration restriction.

27. The apparatus of claim 1, wherein the one or more processors, individually or in any combination, are further operable to cause the apparatus to:
obtain an indication to activate or switch to at least one third cell or at least one third BWP, the indication being obtained in one of an RRC configuration message, a medium access control (MAC) control element (MAC-CE), or downlink control information (DCI),
wherein the at least one third cell or the at least one third BWP are associated with separate configurations for downlink communications and uplink communications, the separate configurations independently including at least one of:
a lack of configuration restriction based on an RRC parameter reference for the at least one third cell or the at least one third BWP,
the configuration restriction based on the RRC parameter reference for the at least one third cell or the at least one third BWP,
a plurality of carrier aggregation capabilities associated with the at least one third cell or the at least one third BWP, or
a timeline for activating or switching to the at least one third cell or the at least one third BWP; and
wherein the separate configurations are independently based on at least one of:
whether the RRC parameter reference and an RRC configuration for the at least one third cell or the at least one third BWP include an identical set of RRC parameters,
whether the RRC parameter reference and the RRC configuration for the at least one third cell or the at least one third BWP include a common set of RRC parameters and a different set of RRC parameters,
whether the at least one third cell lacks or has the configuration restriction based on the RRC parameter reference,
whether the at least one third BWP lacks or has the configuration restriction based on the RRC parameter reference,
whether the at least one third cell and the at least one third BWP both lack the configuration restriction, or
whether the at least one third cell and the at least one third BWP both have the configuration restriction.

28. A method of wireless communication performable at a user equipment (UE), comprising:
obtaining a first radio resource control (RRC) configuration associated with a first carrier, the first carrier being associated with a first cell, a first bandwidth part (BWP) configured for the first cell, or at least one RRC profile respectively including a set of RRC parameters;
generating, at least in part from the first RRC configuration, a second RRC configuration associated with a second carrier, the second carrier being associated with a second cell, a second BWP configured for the second cell, or the at least one RRC profile; and
communicating, with a network entity, over the first carrier and the second carrier.

29. An apparatus for wireless communication, comprising:
one or more memories; and
one or more processors each communicatively coupled with at least one of the one or more memories, the one or more processors, individually or in any combination, operable to cause the apparatus to:
send a first radio resource control (RRC) configuration associated with a first carrier, the first carrier being associated with a first cell, a first bandwidth part (BWP) configured for the first cell, or at least one RRC profile respectively including a set of RRC parameters;
configure a user equipment (UE) to generate, at least in part from the first RRC configuration, a second RRC configuration associated with a second carrier, the second carrier being associated with a second cell, a second BWP configured for the second cell, or the at least one RRC profile; and
communicate, with the UE, over the first carrier and the second carrier.

30. A method of wireless communication performable at a network entity, comprising:
sending a first radio resource control (RRC) configuration associated with a first carrier, the first carrier being associated with a first cell, a first bandwidth part (BWP) configured for the first cell, or at least one RRC profile respectively including a set of RRC parameters;
configuring a user equipment (UE) to generate, at least in part from the first RRC configuration, a second RRC configuration associated with a second carrier, the second carrier being associated with a second cell, a second BWP configured for the second cell, or the at least one RRC profile; and
communicating, with the UE, over the first carrier and the second carrier.
